(19) United States
(12) Patent Application Publication
(10) Pub. No.: US 2022/0259418 A1
(43) Pub. Date: Aug. 18, 2022

(54) Resin Composition, and Multilayer Structure and Packaging Material Using Same

(71) Applicant: KURARAY CO., LTD., Okayama (JP)

(72) Inventors: Takeshi Sakano, Okayama (JP); Tatsuya Oshita, Okayama (JP)

(73) Assignee: KURARAY CO., LTD., Okayama (JP)

(21) Appl. No.: 17/619,547

(22) PCT Filed: Jun. 26, 2020
(86) PCT No.: PCT/JP2020/025380

§ 371 Date: Dec. 15, 2021

(30) Foreign Application Priority Data
Jun. 26, 2019 (JP) 2019-119081
Aug. 9, 2019 (JP) 2019-148045

(51) Int. Cl. C08L 23/16; C08K 5/098; B32B 27/32; B32B 27/08

(52) U.S. Cl. CPC C08L 23/16; C08K 5/098; B32B 27/325; B32B 27/08; B32B 2439/70; C08L 2203/16; B32B 2250/24; B32B 2307/7244; C08L 2201/14

(57) ABSTRACT

A resin composition of the present invention contains an ethylene-cyclic olefin copolymer (A) that includes repeating units including ethylene units and norbornene units having a substituent R¹ and is represented by Formula (I) below, and a transition metal catalyst (B). In the formula, R¹ represents an ethylene group or an ethylene group that is subjected to substitution with an aliphatic hydrocarbon group having 1 to 3 carbon atoms, l and n represent the content ratios of the ethylene units and the norbornene units having a substituent R¹, respectively, and the ratio of l to n (l/n) is 4 or more and 2,000 or less.

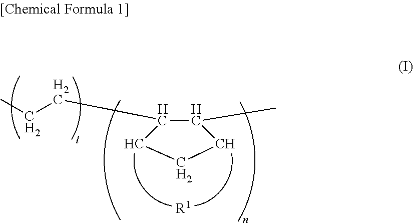

### TECHNICAL FIELD

The present invention relates to a resin composition, and a multilayer structure and a packaging material using the same. More specifically, the invention relates to a resin composition having excellent oxygen-absorbing properties, and a multilayer structure and a packaging material using the same.

### BACKGROUND ART

Gas barrier resins such as ethylene-vinyl alcohol copolymers (hereinafter, also abbreviated as EVOH) are materials having excellent oxygen barrier properties. These resins can be melt-molded, and thus they are preferably used in a multilayer packaging material that includes a layer of such a resin laminated with a layer made of a thermoplastic resin (polyolefin, polyester, etc.) having excellent moisture resistance, excellent mechanical properties, and the like. However, the gas transmission of these gas barrier resins is not completely zero, and they transmit a non-negligible amount of gas. In order to reduce such transmission of gas, especially oxygen, which significantly affects the quality of a content of a package, in particular the quality of food, or in order to absorb and remove oxygen that is already present inside a package at the time of packaging its content, it is known to use a resin composition containing a component having oxygen-absorbing properties as a package material.

For example, Patent Document 1 discloses that a resin composition containing manganese stearate and an ethylene-propylene-diene rubber that includes 5-ethylidene-2-norbornene is used to form an oxygen-absorbing resin layer included in a package material. Patent Document 2 discloses an oxygen-absorbing resin containing a polyolefin resin obtained through polymerization in which a single-site catalyst such as a metallocene catalyst is used. Patent Document 3 discloses an oxygen-absorbing resin composition containing a polyolefin-based resin and an oxidation catalyst that is not supported by a carrier.

EVOH exhibits excellent oxygen barrier properties under a low-humidity condition. On the other hand, when a container made of a multilayer structure that contains EVOH is subjected to high-temperature and high-pressure hot-water treatment such as retort treatment, significant impairment of the oxygen barrier properties, namely a retort shock phenomenon, may occur, thus resulting in loss of the quality of a content in the container. As a resin composition that exhibits high oxygen barrier properties even after retort treatment, Patent Document 4 discloses a resin composition constituted by EVOH, polyoctenylene, and a transition metal catalyst.

### RELATED ART DOCUMENTS

### Patent Documents

Patent Document 1: JP 2010-234718A
Patent Document 2: JP 2005-320513A
Patent Document 3: JP 2007-076365A
Patent Document 4: JP 2008-201432A

### SUMMARY OF THE INVENTION

### Problem to be Solved by the Invention

However, each of the oxygen-absorbing resin compositions disclosed in Patent Documents 1 to 3 has a reasonable level of oxygen-absorbing properties, but a portion of the structure of the resin that is a main component thereof and that exhibits the oxygen-absorbing properties may be decomposed through a reaction with oxygen molecules to produce various volatile decomposition products (e.g., fatty acids such as formic acid, acetic acid, propionic acid, butyric acid, valeric acid, and capronic acid, and aldehydes such as acetaldehyde, propanal, butanal, valeraldehyde, and hexanal) that cause an unpleasant odor. Although the resin composition disclosed in Patent Document 4 exhibits favorable oxygen barrier properties even after retort treatment, the resin may be colored after the retort treatment, and unpleasant odor may be generated due to volatile decomposition products being produced through a side reaction of an oxidation reaction. In particular, when such resin compositions are used in package materials for foods (pet foods) for dogs and cats, which are more sensitive to an odor than humans, and the like, an unpleasant odor caused by these volatile decomposition products may be detestable to food producers and consumers who purchase products packaged in the package materials, and lead to decreased reliability of these products or a decreased willingness to purchase these products.

The present invention was made in order to solve the aforementioned problems, and it is an object thereof to provide a resin composition that has excellent oxygen-absorbing properties, suppresses the intensity of an odor generated after oxygen absorption, and reduces the number of types of volatile decomposition products produced after oxygen absorption, and a multilayer structure and a packaging material in which the resin composition is used.

### Means for Solving the Problem

The present inventions include the following inventions:

[1] A resin composition comprising:

an ethylene-cyclic olefin copolymer (A) that includes repeating units including ethylene units and norbornene units having a substituent R¹ and is represented by Formula (I):

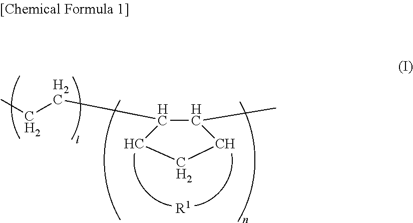

where R¹ represents an ethylene group or an ethylene group that is subjected to substitution with an aliphatic hydrocarbon group having 1 to 3 carbon atoms, l and n represent the content ratios of the ethylene units and the norbornene units having a substituent R¹, respectively, and the ratio of l to n (l/n) is 4 or more and 2,000 or less; and

a transition metal catalyst (B).

[2] The resin composition according to [1], wherein the ethylene-cyclic olefin copolymer (A) includes repeating units including ethylene units, ethylene units having a substituent R², and norbornene units having a substituent R¹ and is represented by Formula (II):

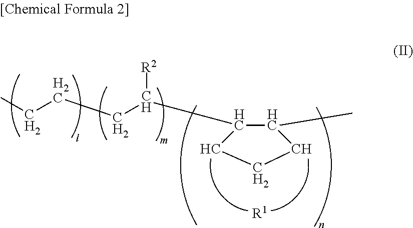

where R¹ represents an ethylene group or an ethylene group that is subjected to substitution with an aliphatic hydrocarbon group having 1 to 3 carbon atoms, R² represents an aliphatic hydrocarbon group having to 8 carbon atoms, l, m, and n represent the content ratios of the ethylene units, the ethylene units having a substituent R², and the norbornene units having a substituent R¹, respectively, and l, m, and n satisfy a relationship represented by Expression (III);

0.0005≤n/(l+m+n)≤0.2 (III).

[3] The resin composition according to [2], wherein R² in Formula (II) is at least one group selected from the group consisting of linear, branched, or cyclic alkyl groups having 1 to 8 carbon atoms; linear, branched, or cyclic alkenyl groups having 2 to 8 carbon atoms; and linear, branched, or cyclic alkynyl groups having 2 to 8 carbon atoms.
[4] The resin composition according to any one of [1] to [3], wherein R¹ in Formula (I) or (II) above is an ethylene group that is subjected to substitution with at least one aliphatic hydrocarbon group selected from the group consisting of linear, branched, or cyclic alkyl groups having 1 to 3 carbon atoms; linear, branched, or cyclic alkenyl groups having 2 to carbon atoms; alkynyl groups having 2 to 3 carbon atoms; and linear or branched alkylidene groups having 2 to 3 carbon atoms.
[5] The resin composition according to any one of [1] to [4], wherein R¹ in Formula (I) or (II) above is an ethylidene ethylene group.
[6] The resin composition according to any one of [1] to [5], wherein a main chain of the ethylene-cyclic olefin copolymer (A) includes only single bonds.
[7] The resin composition according to any one of [1] to [6],

wherein the ethylene-cyclic olefin copolymer (A) is a copolymer that has a branched chain constituted by at least one alkyl group selected from the group consisting of an n-butyl group, an n-pentyl group, and an n-hexyl group, and

in the ethylene-cyclic olefin copolymer (A), the total number of alkyl groups constituting the branched chain per 1,000 carbon atoms determined using ¹³C NMR is 0.001 to 50.

[8] The resin composition according to any one of [1] to [7], which has such oxygen-absorbing properties that oxygen is absorbed in an amount of 0.1 to 300 mL/g for 7 days under the conditions of 60° C. and 10% RH.
[9] The resin composition according to any one of [1] to [8], wherein the content of the transition metal catalyst (B) in terms of a metal atom is 20 to 10,000 ppm.
[10] The resin composition according to any one of [1] to [9], wherein a content X (ppm) of the transition metal catalyst (B) in terms of a metal atom and a content ratio Y (mol %) of the norbornene units having a substituent R¹ to all monomer units included in the ethylene-cyclic olefin copolymer (A) satisfy Expression (IV):

11≤X/Y≤10,000 (IV).

[11] The resin composition according to any one of [2] to [10], wherein a content X (ppm) of the transition metal catalyst (B) in terms of a metal atom, a content ratio Y (mol %) of the norbornene units having a substituent R¹ to all monomer units included in the ethylene-cyclic olefin copolymer (A), and a content ratio Z (mol %) of the ethylene units having a substituent R² to all monomer units included in the ethylene-cyclic olefin copolymer (A) satisfy Expression (V):

0.1≤X/(Y+Z)≤150 (V).

[12] The resin composition according to any one of [1] to [11], wherein the content of the ethylene-cyclic olefin copolymer (A) is 25.0 to 99.9% by mass with respect to the total amount of the resin composition.
[13] The resin composition according to any one of [1] to [11], further comprising an ethylene-vinyl alcohol copolymer (C).
[14] The resin composition according to claim [13], wherein the content of the ethylene-cyclic olefin copolymer (A) is 0.5 to 50% by mass with respect to the total amount of the resin composition.
[15] The resin composition according to [13] or [14], wherein the content of the ethylene-vinyl alcohol copolymer (C) is 50 to 99.5% by mass with respect to the total amount of the resin composition.
[16] The resin composition according to any one of [13] to [15], further comprising an alkaline-earth metal salt, wherein the content of the alkaline-earth metal salt in terms of a metallic element is 1 to 1,000 ppm.
[17] The resin composition according to any one of [1] to [16], further comprising an aluminum compound (D), wherein the aluminum compound is contained in an amount of 0.1 to 10,000 ppm in terms of an aluminum metal atom.
[18] The resin composition according to any one of [1] to [17], further comprising an acetic acid-adsorbing material (E).
[19] The resin composition according to [18], wherein the acetic acid-adsorbing material (E) contains zeolite, and the content of the zeolite is 0.1 to 20% by mass with respect to the total amount of the resin composition.
[20] The resin composition according to [19], wherein the zeolite has an average pore diameter of 0.3 to 1 nm.
[21] The resin composition according to any one of [1] to [20], further comprising an antioxidant (F), wherein the content of the antioxidant is 0.001 to 1% by mass with respect to the total amount of the resin composition.
[22] The resin composition according to any one of [1] to [21],

wherein the ethylene-cyclic olefin copolymer (A) has an MFR of 2 g/10 minutes or less at 190° C. under a load of 2,160 g,

a viscosity modifier having an MFR of 10 g/10 minutes or more at 190° C. under a load of 2,160 g is further contained, and

the content of the viscosity modifier is 1 to 30% by mass with respect to the total amount of the resin composition.

[23] A multilayer structure comprising at least one oxygen-absorbing layer containing the resin composition according to any one of [1] to [22].
[24] The multilayer structure according to [23], comprising at least one gas barrier resin layer.
[25] A packaging material made of the multilayer structure according to [24].
[26] A packaged product comprising:

a content; and

the packaging material according to [25] for enclosing the content,

wherein the oxygen-absorbing layer in the packaging material is arranged between the gas barrier resin layer in the packaging material and the content.

[27] The packaged product according to [26], wherein the content is food.

### Effects of the Invention

With the present invention, excellent oxygen-absorbing properties can be achieved, and volatile decomposition products can be prevented from being produced during oxygen absorption to suppress generation of an unpleasant odor caused by these volatile decomposition products. As a result, it is possible to provide, for example, a container and a package material such as a multilayer film and a multilayer container suited to store products such as foods that tend to deteriorate due to oxygen.

### BRIEF DESCRIPTION OF DRAWINGS

FIG. 1 is a GC-MS graph indicating the results of confirmation of whether or not volatile decomposition products are present that are produced while oxygen is absorbed by oxygen-absorbing films prepared in Example I-1 and Comparative Example I-3. The result shown in the lower side of this diagram is obtained from the oxygen-absorbing film prepared in Example I-1, and the result shown in the upper side in this diagram is obtained from the oxygen-absorbing film prepared in Comparative Example I-3.

### DESCRIPTION OF EMBODIMENTS

(1) Resin Composition

A resin composition of the present invention contains an ethylene-cyclic olefin copolymer (A) and a transition metal catalyst (B).

Ethylene-Cyclic Olefin Copolymer (A)

The ethylene-cyclic olefin copolymer (A) is a random copolymer represented by Formula (I) that includes, for example, repeating units including ethylene units and norbornene units having a substituent R¹.

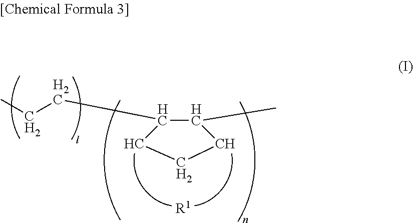

In Formula (I), R¹ represents an ethylene group, or an ethylene group in which at least one hydrogen atom included in the ethylene group is substituted with an aliphatic hydrocarbon group having 1 to 3 carbon atoms. More specific examples of the aliphatic hydrocarbon group having 1 to 3 carbon atoms included in R¹ include linear, branched, or cyclic alkyl groups having 1 to 3 carbon atoms (i.e., linear alkyl groups having 1 to 3 carbon atoms, a branched alkyl group having 3 carbon atoms, and a cyclic alkyl group having 3 carbon atoms are encompassed); linear, branched, or cyclic alkenyl groups having 2 to 3 carbon atoms (i.e., linear alkenyl groups having 1 to 3 carbon atoms, a branched alkenyl group having 3 carbon atoms, and a cyclic alkenyl group having 3 carbon atoms are encompassed); alkynyl groups having 2 to 3 carbon atoms (i.e., linear alkynyl groups having 2 to 3 carbon atoms are encompassed); and linear or branched alkylidene groups having 2 to 3 carbon atoms (i.e., linear alkylidene groups having 2 to 3 carbon atoms and a branched alkylidene group having 3 carbon atoms are encompassed).

Examples of the linear, branched, or cyclic alkyl groups having 1 to 3 carbon atoms that may be included in R¹ include a methyl group, an ethyl group, an n-propyl group, an isopropyl group, and a cyclopropyl group. Examples of the linear, branched, or cyclic alkenyl groups having 2 to 3 carbon atoms that may be included in R¹ include a vinyl group, a 1-propenyl group, a 2-propenyl group, and a cyclopropenyl group. Examples of the linear or branched alkynyl groups having 2 to 3 carbon atoms that may be included in R¹ include an ethynyl group, a 1-propynyl group, and a 2-propynyl group (propargyl group). Examples of the linear or branched alkylidene groups having 2 to 3 carbon atoms that may be included in R¹ include an ethylidene group, a 1-propylidene group, and a 2-propylidene group. In Formula (I), R¹ is preferably an ethylidene ethylene group.

In Formula (I), l and n represent the content ratios of the ethylene units and the norbornene units having a substituent R¹, respectively, and the ratio of l to n (l/n) is 4 or more and 2,000 or less, preferably 5 or more and 500 or less, and more preferably 10 or more and or less. If the ratio of l to n is less than 4 in Formula (I), the glass-transition temperature of the resin will increase, which may result in an insufficient oxygen absorbing speed. If the ratio of l to n is more than 2,000, the obtained copolymer may be incapable of exhibiting sufficient oxygen-absorbing properties because the ratio of the norbornene units included in the copolymer is too small.

Note that, in the norbornene units having a substituent R¹ included in the ethylene-cyclic olefin copolymer (A), the substituents R¹ may include a single type of monomer unit or two or more different types of monomer units.

It is preferable that the ethylene-cyclic olefin copolymer (A) is a random copolymer represented by Formula (II) that includes repeating units including ethylene units, ethylene units having a substituent R², and norbornene units having a substituent R¹.

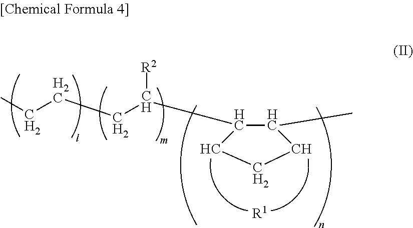

R¹ in Formula (II) is the same as that defined in Formula (I) above. In Formula (II), R¹ is preferably an ethylidene ethylene group. R² is an aliphatic hydrocarbon group having 1 to 8 carbon atoms, preferably a linear, branched, or cyclic alkyl group having 1 to 8 carbon atoms; a linear, branched, or cyclic alkenyl group having 2 to 8 carbon atoms; or a linear, branched, or cyclic alkynyl group having 2 to 8 carbon atoms, and more preferably a linear, branched, or cyclic alkyl group having 1 to 3 carbon atoms; a linear, branched, or cyclic alkenyl group having 2 to 3 carbon atoms; or an alkynyl group having 2 to 3 carbon atoms. The term “linear, branched, or cyclic alkyl group having 1 to 8 carbon atoms” as used herein encompasses linear alkyl groups having 1 to 8 carbon atoms, branched alkyl groups having 3 to 8 carbon atoms, and cyclic alkyl groups having 3 to 8 carbon atoms. The term “linear, branched, or cyclic alkenyl group having 2 to 8 carbon atoms” as used herein encompasses linear alkenyl groups having 2 to 8 carbon atoms, branched alkenyl groups having 3 to 8 carbon atoms, and cyclic alkenyl groups having 3 to 8 carbon atoms. The term “linear, branched, or cyclic alkynyl group having 2 to 8 carbon atoms” as used herein encompasses linear alkynyl groups having 2 to 8 carbon atoms, branched alkynyl groups having 3 to 8 carbon atoms, and cyclic alkynyl groups having 3 to carbon atoms.

Examples of the linear, branched, or cyclic alkyl group having 1 to 8 carbon atoms that may be included in R² include a methyl group, an ethyl group, an n-propyl group, an isopropyl group, an n-butyl group, an isobutyl group, a sec-butyl group, a tert-butyl group, an n-pentyl group, an isopentyl group, a neopentyl group, a 3-pentyl group, an n-hexyl group, an n-heptyl group, a 4-heptyl group, an n-octyl group, a cyclopropyl group, a cyclobutyl group, a cyclopentyl group, and a cyclohexyl group. Examples of the linear, branched, or cyclic alkenyl group having 2 to 8 carbon atoms that may be included in R² include a vinyl group, a 1-propenyl group, a 2-propenyl group, an isopropenyl group, a 1-butenyl group, a 2-butenyl group, a 3-butenyl group, an isobutenyl group, a 1-pentenyl group, a 2-pentenyl group, a 3-pentenyl group, a 4-pentenyl group, an isopentenyl group, a cyclopentenyl group, a 1-hexenyl group, a 2-hexenyl group, a 3-hexenyl group, a 4-hexenyl group, a 5-hexenyl group, a cyclohexenyl group, a 1-heptenyl group, a 2-heptenyl group, a 3-heptenyl group, a 4-heptenyl group, a 5-heptenyl group, a 6-heptenyl group, a 1-octenyl group, a 2-octenyl group, a 3-octenyl group, a 4-octenyl group, a 5-octenyl group, a 6-octenyl group, and a 7-octenyl group. Examples of the linear, branched, or cyclic alkynyl group having 2 to 8 carbon atoms that may be included in R² include an ethynyl group, a 1-propynyl group, a 2-propynyl group, a 1-butynyl group, a 2-butynyl group, a 3-butynyl group, a 1-pentynyl group, a 2-pentynyl group, a 3-pentynyl group, a 4-pentynyl group, a 1-hexynyl group, a 2-hexynyl group, a 3-hexynyl group, a 4-hexynyl group, a 5-hexynyl group, a 1-heptynyl group, a 2-heptynyl group, a 3-heptynyl group, a 4-heptynyl group, a 5-heptynyl group, a 6-heptynyl group, a 1-octynyl group, a 2-octynyl group, a 3-octynyl group, a 4-octynyl group, a 5-octynyl group, a 6-octynyl group, and a 7-octynyl group. In Formula (II), R² is preferably a methyl group or ethyl group.

In Formula (II), l, m, and n represent the content ratios of the ethylene units, the ethylene units having a substituent R², and the norbornene units having a substituent R¹, respectively, and it is preferable that the ratio (n/(l+m+n)) of n to the sum of l, m, and n (l+m+n) satisfies Relational Expression (III) below:

0.0005≤n/(l+m+n)≤0.2 (III).

Furthermore, this ratio (n/(l+m+n)) is preferably 0.008 or more and 0.08 or less, and more preferably 0.01 or more and 0.05 or less. If the ratio (n/(l+m+n)) is less than 0.0005 in Formula (II), sufficient oxygen-absorbing properties may be incapable of being exhibited. If the ratio (n/(l+m+n)) is more than 0.2, the glass-transition temperature of the resin will increase, which may result in an insufficient oxygen absorbing speed.

Note that, in the norbornene units having a substituent R¹ and the ethylene units having a substituent R² included in the ethylene-cyclic olefin copolymer (A), the substituents R¹ and the substituents R² both may include a single type of monomer unit or two or more different types of monomer units.

In the present invention, it is preferable that the ethylene-cyclic olefin copolymer (A) represented by Formula (I) or (II) above has a configuration in which the main chain in the structure shown in Formula (I) or (II) includes only single bonds, that is, the main chain includes no unsaturated bonds such as double bonds.

In general, when the main chain included in the repeating unit structure includes an unsaturated bond (a double bond or triple bond), an unsaturated bond included in a ring moiety that is not included in the main chain in this structure is more reactive than an unsaturated bond included in the main chain, and therefore, it can be expected that the amount of oxygen absorbed by this ring moiety at room temperature increases. Accordingly, when the ring moiety includes an unsaturated bond, the unsaturation of the ring moiety that is not included in the main chain preferentially absorbs oxygen before the unsaturated bond in the main chain moiety absorbs oxygen, and thus oxygen absorption by the unsaturated bond in the main chain moiety can be delayed to the extent possible. As a result, the main chain is less likely to be cleaved, and thus new production of odor components caused by this cleavage is suppressed. However, even in such a case, if the main chain includes an unsaturated bond, there will be a possibility that, if only slightly, the main chain is cleaved.

On the other hand, when the main chain of the ethylene-cyclic olefin copolymer (A) represented by Formula (I) or (II) above includes only single bonds, a reaction for oxygen absorption is mainly caused by the unsaturated bond included in the ring moiety, and thus a state can be maintained in which the possibility of main chain cleavage is further reduced.

Accordingly, in the present invention, a possibility that odor components are produced due to main chain cleavage, particularly a possibility that low-molecular-weight odor components (e.g., volatile decomposition products such as fatty acids including propionic acid, butyric acid, valeric acid, and capronic acid, and aldehydes including acetaldehyde, pentanal, butanal, and hexanal) are produced due to main chain cleavage, is further reduced.

The weight average molecular weight (Mw) of the ethylene-cyclic olefin copolymer (A) in terms of standard polystyrene is preferably 5,000 to 500,000, more preferably 10,000 to 300,000, and even more preferably 20,000 to 200,000. If the weight average molecular weight (Mw) of the ethylene-cyclic olefin copolymer (A) is less than 5,000, the mold processability and handlability of the resin composition may be poor, and when processed into a molded product, mechanical properties such as rigidity and stretchability may be poor. If the weight average molecular weight (Mw) of the ethylene-cyclic olefin copolymer (A) is more than 500,000, the viscosity of the ethylene-cyclic olefin copolymer (A) increases, which may result in impairment of the mold processability thereof. In addition, when such an ethylene-cyclic olefin copolymer (A) is mixed with another resin such as a gas barrier resin and the resulting mixture is used, the dispersibility of the ethylene-cyclic olefin copolymer (A) is poor, and therefore, the oxygen-absorbing function may be impaired, and the gas barrier resin may be incapable of sufficiently exhibiting its properties (e.g., gas barrier properties).

It is preferable that the ethylene-cyclic olefin copolymer (A) has a branched chain (referred to as “another branched chain” hereinafter) having 4 or more carbon atoms to a certain extent as a whole, that is, the copolymer has such a branched chain in addition to R¹ in Formulae (I) and (II) above or R² in Formula (II) above. Examples of such another branched chain include alkyl groups such as an n-butyl group, n-pentyl group, and n-hexyl group. Furthermore, in the ethylene-cyclic olefin copolymer (A), the total number of alkyl groups constituting the other branched chains per 1,000 carbon atoms determined using ¹³C NMR as described in Examples below is preferably 0.001 to 50, more preferably 0.002 to 5, and even more preferably 0.003 to 3. If the total number of alkyl groups is within this range, the crystalizability will moderately decrease, and favorable mold processability will be achieved. In addition, generation of an odor due to fatty acids and aldehydes having 4 or more carbon atoms being produced through a side reaction of an oxidation reaction can be suppressed.

The ethylene-cyclic olefin copolymer (A) used in the present invention can be synthesized using a known method such as a coordination polymerization method or radical polymerization method. A specific example of the coordination polymerization method is the method as described in a non-patent document, Polymers, 2017, 9, 353.

Known catalysts for olefin coordination polymerization can be used as a polymerization catalyst to be used to synthesize the ethylene-cyclic olefin copolymer (A) in the coordination polymerization method. Examples of the catalysts for olefin coordination polymerization include multi-site catalysts such as Ziegler-Natta catalysts and Phillips catalysts, and single-site catalysts such as metallocene catalysts.

In particular, using a single-site catalyst makes it possible to synthesize the ethylene-cyclic olefin copolymer (A) while controlling the branching degree to a low level. Using a Ziegler-Natta catalyst constituted by a combination of a soluble vanadium compound such as vanadium oxyethoxide dichloride and a blend containing ethylaluminum dichloride and diethylaluminum chloride in equal proportions makes it possible to synthesize the ethylene-cyclic olefin copolymer (A) while achieving a certain branching degree and controlling the molecular weight distribution in a narrow range. The branching degree can be adjusted to be in a preferable range by selecting a catalyst as necessary. Moreover, the branching degree in the resin composition can be adjusted by mixing a plurality of types of ethylene-cyclic olefin copolymers (A) that were separately polymerized.

Using an aluminum compound as a catalyst or cocatalyst makes it possible to further improve the oxygen-absorbing properties of a product (resin composition) obtained by kneading the ethylene-cyclic olefin copolymer (A) obtained using such a catalyst or cocatalyst with a transition metal catalyst (B) and an EVOH (C), which will be described later.

When an aluminum compound is used as a catalyst or cocatalyst to synthesize the ethylene-cyclic olefin copolymer (A), the aluminum compound may react with the polymer that is present therearound and be thus incorporated in the polymer. The content of the thus incorporated aluminum compound in, for example, a resin composition that includes the ethylene-cyclic olefin copolymer (A), and a transition metal catalyst (B) and an EVOH (C), which will be described later, can be quantified by extracting the ethylene-cyclic olefin copolymer (A) from the resin composition in a non-polar solvent such as cyclohexane or toluene, isolating the ethylene-cyclic olefin copolymer (A) through concentration or reprecipitation in a polar solvent such as acetone, wet-degrading the isolated ethylene-cyclic olefin copolymer (A) through micro-wave heating in strong acid, and performing quantification using an analysis means such as ICP-MS.

It is preferable that the ratio of the melt flow rate (MFR) of the ethylene-cyclic olefin copolymer (A) to the MFR of the EVOH (C), namely MFR(A)/MFR(C), is within a range of 0.1 to 10. When the ratio MFR(A)/MFR(C) is within this range, both of these compounds are favorably dispersed during melt-kneading. As a result, favorable productivity is achieved due to the amount of die buildup produced in a die during melt-kneading being reduced, and a favorable external appearance is obtained due to the number of aggregates in the molded product being reduced. The MFR as referred herein is a value obtained by measuring the ethylene-cyclic olefin copolymer (A) at 190° C. under a load of 2,160 g.

Some ethylene-cyclic olefin copolymers (A) are commercially available, and, for example, an EPDM (ethylene propylene diene rubber) elastomer constituted by ethylene monomers, propylene monomers, and ethylidene norbornene monomers, and a cycloolefin copolymer constituted by ethylene monomers and norbornene monomers are known. Such a commercially available product may contain a lubricant and an antioxidant as additives. These additives may be removed as necessary through agitation washing in an organic solvent or reprecipitation. Specifically, the additives can be removed by dissolving the EPDM elastomer or cycloolefin copolymer in a cyclohexane solvent in an oil bath at 90° C. and performing reprecipitation in acetone, which is a poor solvent. The additives can be more easily removed by subjecting pellets of the EPDM elastomer or the like to reflux agitation in acetone. It is preferable that commercially available ethylene-cyclic olefin copolymer (A) products to be used in the present invention also contain an aluminum compound. Among such products, products that satisfy the following condition are more preferable: even when the additive-removal processing as mentioned above is performed, the aluminum compound remains. Examples of such commercially available ethylene-cyclic olefin copolymer (A) products include “Mitsui EPT K-9720” (manufactured by Mitsui Chemicals, Inc., MFR (190° C., 2,160 g load)=2 g/10 minutes), “NORDEL IP4820P” (manufactured by Dow Chemical Company, MFR=1 g/10 minutes), “NORDEL IP4770P” (manufactured by Dow Chemical Company, MFR=0.07 g/10 minutes), “NORDEL IP4725P” (manufactured by Dow Chemical Company, MFR=0.7 g/10 minutes), and “TOPAS E-140” (manufactured by Polyplastics Co., Ltd., MFR=3 g/10 minutes).

The content of the ethylene-cyclic olefin copolymer (A) in the resin composition of the present invention is, for example, 0.01 to 99.99% by mass with respect to the total amount of the resin composition.

In the case where the resin composition of the present invention does not contain the EVOH (C), which will be described later, the content of the ethylene-cyclic olefin copolymer (A) is preferably 25.0 to 99.9% by mass, more preferably 30 to 99.8% by mass, and even more preferably 40 to 99.6% by mass. In the case where the resin composition of the present invention does not contain the EVOH (C), if the content of the ethylene-cyclic olefin copolymer (A) in the resin composition is less than 25.0% by mass, the oxygen-absorbing properties of the obtained resin composition may be insufficient. If the content of the ethylene-cyclic olefin copolymer (A) is more than 99.99% by mass, the addition amounts of a transition metal catalyst for oxidation and the like will be small, and thus the oxygen-absorbing properties may be insufficiently exhibited.

Alternatively, in the case where the resin composition of the present invention contains the EVOH (C), which will be described later, the content of the ethylene-cyclic olefin copolymer (A) is preferably 0.01 to 99.0% by mass, more preferably 0.5 to 50% by mass, and even more preferably 1.0 to 20% by mass. In the case where the resin composition of the present invention contains the EVOH (C), if the content of the ethylene-cyclic olefin copolymer (A) in the resin composition is less than 0.01% by mass, the oxygen-absorbing properties of the obtained resin composition may be insufficient. If the content of the ethylene-cyclic olefin copolymer (A) is more than 90% by mass, the content of the EVOH (C) will be relatively low, and thus the gas barrier properties may be insufficiently exhibited.

Transition Metal Catalyst (B)

The transition metal catalyst (B) is a compound that plays a role in promoting oxygen absorption by oxidizing the above-mentioned ethylene-cyclic olefin copolymer (A). The transition metal catalyst (B) is preferably in the form of an inorganic acid salt, organic acid salt, or complex salt of a transition metal. The transition metal atom included in the transition metal catalyst (B) is selected from metal atoms belonging to the group VIII in the periodic table, such as iron, cobalt, and nickel; metal atoms belonging to the group I in the periodic table, such as copper and silver; metal atoms belonging to the group IV in the periodic table, such as tin, titanium, and zirconium; metal atoms belonging to the group V in the periodic table, such as vanadium; metal atoms belonging to the group VI in the periodic table, such as chromium; metal atoms belonging to the group VII in the periodic table, such as manganese; and combinations thereof. The transition metal atom included in the transition metal catalyst (B) is preferably manganese or cobalt because these metal atoms are very versatile, and the above-mentioned ethylene-cyclic olefin copolymer (A) can be efficiently oxidized.

Examples of the transition metal catalyst (B) in the form of an inorganic acid salt include halides such as chlorides; sulfur-containing oxyacid salts such as sulfates; nitrogen-containing oxyacid salts such as nitrates; phosphorus-containing oxyacid salts such as phosphates; and silicates that each contain any of the transition metal atoms listed above. Examples of the transition metal catalyst (B) in the form of an organic acid salt include acetates, propionates, isopropionates, butanoates, isobutanoates, pentanoates, isopentanoates, hexanoates, heptanoates, isoheptanoates, octanoates, 2-ethylhexanoates, nonanoates, 3,5,5-trimethylhexanoates, decanoates, neodecanoates, undecanoates, laurates, myristates, palmitates, margarates, stearates, arachiates, linderates, tsuzuates, petroselinates, oleates, linoleates, linolenates, arachidonates, formates, oxalates, sulfamates, and nap hthenates that each contain any of the transition metal atoms listed above. Examples of the transition metal catalyst (B) in the form of a complex salt include complexes that include any of the transition metal atoms listed above and a β-diketone or β-keto acid ester. Specific examples of the β-diketone and β-keto acid ester include acetylacetone, ethyl acetoacetate, 1,3-cyclohexadione, methylenebis-1,3-cyclohexadione, 2-benzyl-1,3-cyclohexadione, acetyltetralone, palmitoyltetralone, stearoyltetralone, benzoyltetralone, 2-acetylcyclohexanone, 2-benzoylcyclohexanone, 2-acetyl-1,3-cyclohexanedione, benzoyl-p-chlorobenzoylmethane, bis(4-methylbenzoyl)methane, bis(2-hydroxybenzoyl)methane, benzoylacetone, tribenzoylmethane, diacetylbenzoylmethane, stearoylbenzoylmethane, palmitoylbenzoylmethane, lauroylbenzoylmethane, dibenzoylmethane, bis(4-chlorobenzoyl)methane, bis(methylene-3,4-dioxybenzoyl)methane, benzoylacetylphenylmethane, stearoyl(4-methoxybenzoyl)methane, butanoylacetone, distearoylmethane, acetylacetone, stearoylacetone, bis(cyclohexanoyl)-methane, and dipivaloylmethane.

The transition metal catalyst (B) is preferably manganese stearate, cobalt stearate, manganese 2-ethylhexanoate, cobalt 2-ethylhexanoate, manganese neodecanoate, cobalt neodecanoate, or a combination thereof because these compounds are very versatile, and the above-mentioned ethylene-cyclic olefin copolymer (A) can be efficiently oxidized.

The content of the transition metal catalyst (B) in terms of the metal atom is preferably 20 to 10,000 ppm, more preferably 50 to 1,000 ppm, and even more preferably 100 to 500 pm, with respect to the mass of the above-mentioned ethylene-cyclic olefin copolymer (A). If the content of the transition metal catalyst (B) is less than 20 ppm in terms of the metal atom, the oxygen-absorbing properties of the obtained resin composition may be insufficient. If the content of the transition metal catalyst (B) is more than 10,000 ppm in terms of the metal atom, the transition metal catalyst (B) aggregates in the obtained resin composition, and the external appearance may deteriorate due to generation of abnormal matter or streaks.

Also, it is preferable to configure the resin composition of the present invention such that the ratio (X/Y) of the content X (ppm) of the transition metal catalyst (B) in terms of the metal atom to the content ratio Y (mol %) of the above-mentioned norbornene units having a substituent R¹ to all the monomer units included in the above-mentioned ethylene-cyclic olefin copolymer (A) satisfies Relational Expression (IV) below:

11≤X/Y≤10,000 (IV).

This ratio (X/Y) is preferably 30 or more and 3,000 or less, and more preferably 100 or more and 1,000 or less. If the ratio (X/Y) is within the range mentioned above, sufficient oxygen-absorbing properties are obtained while the favorable external appearance of the molded product is maintained. If the ratio (X/Y) is less than 11 in Formula (IV), sufficient oxygen absorbing speed may be incapable of being obtained. If the ratio (X/Y) is more than 10,000, the hue of the obtained resin composition may deteriorate. In addition, the transition metal catalyst (C) may aggregate in the resin composition, and the external appearance may deteriorate due to generation of abnormal matter or streaks.

Alternatively, it is preferable to configure the resin composition of the present invention such that the ratio (X/(Y+Z)) regarding the content X (ppm) of the transition metal catalyst (B) in terms of the metal atom, the content ratio Y (mol %) of the norbornene units having a substituent R¹ to all the monomer units included in the above-mentioned ethylene-cyclic olefin copolymer (A), and the content ratio Z (mol %) of the ethylene units having a substituent R² to all the monomer units included in the ethylene-cyclic olefin copolymer (A) satisfies Relational Expression (V) below:

0.1≤X/(Y+Z)≤150 (V).

This ratio (X/(Y+Z)) is preferably 1.5 or more and 100 or less, and more preferably 10 or more and 40 or less. If the ratio (X/(Y+Z)) is within the range mentioned above, sufficient oxygen-absorbing properties are obtained without generating an unpleasant odor. If the ratio (X/(Y+Z)) is less than 0.1 in Formula (V), sufficient oxygen absorbing speed may be incapable of being obtained. If the ratio (X/(Y+Z)) is more than 150, an unpleasant odor may be generated during oxygen absorption.

EVOH (C)

The resin composition of the present invention may further contain an EVOH (C) in addition to the ethylene-cyclic olefin copolymer (A) and the transition metal catalyst (B).

The EVOH (C) can be obtained, for example, through saponification of an ethylene-vinyl ester copolymer. An ethylene-vinyl ester copolymer can be manufactured and saponified using known methods. Examples of vinyl ester that can be used in this method include fatty acid vinyl esters such as vinyl acetate, vinyl formate, vinyl propionate, vinyl pivalate, and vinyl versatate.

In the present invention, the ethylene content in the EVOH (C) is preferably 5 to 60 mol %, more preferably 15 to 55 mol %, and even more preferably 20 to 50 mol %. If the ethylene content is less than 5 mol %, the molten moldability and the oxygen barrier properties at high temperatures tend to be impaired. If the ethylene unit content is more than 60 mol %, the oxygen barrier properties tend to be impaired. Such an ethylene unit content in EVOH (C) can be measured using, for example, a nuclear magnetic resonance (NMR) technique.

In the present invention, the lower limit of the saponification degree of the vinyl ester component in the EVOH (C) is preferably 90 mol % or more, more preferably 95 mol % or more, and even more preferably 99 mol % or more. If the saponification degree is 90 mol % or more, the oxygen barrier properties of the resin composition can be improved, for example. On the other hand, the upper limit of the saponification degree of the vinyl ester component in the EVOH (C) may be, for example, 100 mol % or less, or 99.99 mol % or less. The saponification degree of the EVOH (C) can be calculated by measuring the peak area of hydrogen atoms contained in the vinyl ester structure and the peak area of hydrogen atoms contained in the vinyl alcohol structure through ¹H-NMR measurement. Setting the saponification degree of the EVOH (C) to be within the above-mentioned range makes it possible to provide favorable oxygen barrier properties to the resin composition of the present invention.

The EVOH (C) may also include a unit derived from another monomer other than ethylene, vinyl ester, and saponified products thereof to the extent that the object of the present invention is not inhibited. When the EVOH (C) includes the other monomer unit as mentioned above, the upper limit of the other monomer unit content in all the structural units of the EVOH (C) is, for example, 30 mol % or less, mol % or less, 10 mol % or less, or 5 mol % or less. Furthermore, when the EVOH (C) includes the unit derived from the other monomer, the lower limit of the content thereof is, for example, 0.05 mol % or more or 0.1 mol % or more.

Examples of such another monomer that may be included in the EVOH (C) include alkenes such as propylene, butylene, pentene, and hexene; ester group-containing alkenes such as 3-acyloxy-1-propene, 3-acyloxy-1-butene, 4-acyloxy-1-butene, 3,4-diacyloxy-1-butene, 3-acyloxy-4-methyl-1-butene, 4-acyloxy-1-butene, 3,4-diacyloxy-1-butene, 3-acyloxy-4-methyl-1-butene, 4-acyloxy-2-methyl-1-butene, 4-acyloxy-3-methyl-1-butene, 3,4-diacyloxy-2-methyl-1-butene, 4-acyloxy-1-pentene, 5-acyloxy-1-pentene, 4,5-diacyloxy1-pentene, 4-acyloxy-1-hexene, 5-acyloxy-1-hexene, 6-acyloxy-1-hexene, 5,6-diacyloxy-1-hexene, and 1,3-deacetoxy-2-methylenepropane, or saponified products thereof; unsaturated acids such as acrylic acid, methacrylic acid, crotonic acid, and itaconic acid, or anhydrides, salts, monoalkyl esters, or dialkyl esters thereof; nitriles such as acrylonitrile and methacrylonitrile; amides such as acrylamide and methacrylamide; olefin sulfonic acid such as vinyl sulfonic acid, allyl sulfonic acid, and methallyl sulfonic acid, or salts thereof; vinylsilane compounds such as vinyltrimethoxysilane, vinyltriethoxysilane, vinyltri(6-methoxy-ethoxy) silane, and γ-methacryloxypropylmethoxysilane; alkyl vinyl ethers, vinyl ketones, N-vinylpyrrolidone, vinyl chloride, and vinylidene chloride.

The EVOH (C) may be modified through techniques such as urethanation, acetalation, cyanoethylation, and oxyalkylenation. The thus-modified EVOH tends to improve the molten moldability of the resin composition of the present invention.

A combination of two or more types of EVOH that differs in the ethylene unit content, the saponification degree, the copolymer component, whether or not they are modified, the modification type, or the like may be used as the EVOH (C).

The EVOH (C) can be obtained using a known technique such as bulk polymerization, solution polymerization, suspension polymerization, or emulsion polymerization. In one embodiment, bulk polymerization or solution polymerization in which polymerization can be performed using no solvent or in a solution such as alcohol is used.

There is no particular limitation on a solvent used in solution polymerization, and examples thereof include alcohols, preferably lower alcohols such as methanol, ethanol, and propanol. It is sufficient that the amount of a solvent used in a polymerization reaction solution is selected in consideration of the target viscosity-average polymerization degree of the EVOH (C) or the chain transfer of the solvent, and the ratio (solvent/total monomers) of the mass of the solvent contained in the reaction solution to the total mass of monomers contained therein is, for example, 0.01 to 10, and preferably 0.05 to 3.

Examples of a catalyst used in the above-mentioned polymerization include azo-based initiators such as 2,2-azobisisobutyronitrile, 2,2-azobis-(2,4-dimethylvaleronitrile), 2,2-azobis-(4-methoxy-2,4-dimethylvaleronitrile), and 2,2-azobis-(2-cyclopropylpropionitrile); and organic peroxide-based initiators such as isobutyryl peroxide, cumyl peroxyneodecanoate, diisopropyl peroxycarbonate, di-n-propyl peroxydicarbonate, t-butyl peroxyneodecanoate, lauroyl peroxide, benzoyl peroxide, and t-butyl hydroperoxide.

The polymerization temperature is preferably 20° C. to 90° C., and more preferably 40° C. to 70° C. The polymerization time is preferably 2 hours to 15 hours, and more preferably 3 hours to 11 hours. The polymerization rate is preferably 10% to 90%, and more preferably 30% to 80%, with respect to vinyl ester prepared for the polymerization. The resin content in the solution after the polymerization is preferably 5% to 85%, and more preferably 20% to 70%.

In the above-mentioned polymerization, after polymerization is performed for a predetermined period of time or a predetermined polymerization rate is obtained, a polymerization inhibitor is added as necessary, unreacted ethylene gas is removed through evaporation, and unreacted vinyl ester can be removed.

Then, an alkaline catalyst is added to the copolymer solution, and the copolymer is saponified. A continuous saponification method or batch saponification method may be employed. Examples of the alkaline catalyst that can be added include sodium hydroxide, potassium hydroxide, and alkali metal alcoholates.

The EVOH (C) that has been subjected to the saponification reaction contains the alkaline catalyst, by-product salts such as sodium acetate and potassium acetate, and other impurities. Accordingly, it is preferable to remove these compounds as necessary through neutralization or washing. Here, when the EVOH (C) that has been subjected to the saponification reaction is washed with water (e.g., ion-exchanged water) that is substantially free of predetermined ions (e.g., metal ions and chloride ions), by-product salts such as sodium acetate and potassium acetate need not be entirely removed, and a portion thereof may remain.

The content of the EVOH (C) in the resin composition of the present invention may be 10 to 99.99% by mass with respect to the total amount of the resin composition, and is preferably 50 to 99.5% by mass, and more preferably 80 to 99% by mass. If the content of the EVOH (C) in the resin composition is less than 10% by mass, the oxygen barrier properties of the obtained resin composition may be insufficient. If the content of the EVOH (C) is more than 99.99% by mass, the oxygen-absorbing properties of the obtained resin composition may be insufficient.

Aluminum Compound (D)

The resin composition of the present invention may further contain an aluminum compound (D) in addition to the ethylene-cyclic olefin copolymer (A) and the transition metal catalyst (B).

In the resin composition of the present invention, the aluminum compound (D) may be added as a catalyst or cocatalyst as described above during the synthesis of the ethylene-cyclic olefin copolymer (A), or may be separately added as another additive.

When contained in the ethylene-cyclic olefin copolymer (A), the aluminum compound (D) may directly bind to the polymer chain through a covalent bond, an ionic bond, a coordination bond, or the like. Examples of the aluminum compound (D) include aluminum metal or oxides containing aluminum; salts (e.g., chlorides, sulfates, nitrates, hydroxides, and carboxylates); organic aluminum; and organic aluminoxanes (polyalkyl aluminoxanes obtained through a reaction between trialkyl aluminum and water). These aluminum compounds may be used alone or in combination of two or more. Examples of the oxides of aluminum include a-alumina, 6-alumina, and y-alumina. Examples of the chlorides of aluminum include anhydrous aluminum chloride, aluminum (III) chloride hexahydrate, and polyaluminum chloride. An example of the sulfides of aluminum is aluminum sulfide. Examples of the carboxylates of aluminum include aluminum acetate, aluminum formate, aluminum oxalate, aluminum citrate, aluminum malate, aluminum stearate, and aluminum tartrate. Examples of the organic aluminum include trimethyl aluminum, triethyl aluminum, tripropyl aluminum, tributyl aluminum, triisobutyl aluminum, dimethyl aluminum chloride, methyl aluminum dichloride, diethyl aluminum chloride, and ethyl aluminum dichloride. Examples of the organic aluminoxanes include polymethyl aluminoxane, polyethyl aluminoxane, polypropyl aluminoxane, polybutyl aluminoxane, polyisobutyl aluminoxane, polymethylethyl aluminoxane, polymethylbutyl aluminoxane, and polymethylisobutyl aluminoxane. In particular, the organic aluminum and polyalkyl aluminoxanes are preferable, and polymethyl aluminoxane and polymethylisobutyl aluminoxane are more preferable.

The content of the aluminum compound (D) in terms of the aluminum metal atom is preferably 0.1 to 10,000 ppm, more preferably 0.5 to 10,000 ppm, and even more preferably 1 to 50 ppm, with respect to the total mass of the resin composition. If the content of the aluminum compound (D) satisfies such a range, coloring of a resin composition can be suppressed during melt-kneading and molding processing, and a resin composition exhibiting favorable oxygen-absorbing properties can be obtained.

Acetic Acid-Adsorbing Material (E)

The resin composition of the present invention may further contain an acetic acid-adsorbing material (E) in addition to the ethylene-cyclic olefin copolymer (A) and the transition metal catalyst (B).

The term “acetic acid-adsorbing material” as used herein refers to a material that can adsorb acetic acid or acetic acid gas that may be produced due to oxidation of a resin, and also encompasses a material that can adsorb another low-molecular-weight compound in addition to acetic acid or acetic acid gas. The low-molecular-weight compound that can be adsorbed by the acetic acid-adsorbing material (E) is, for example, a volatile decomposition product that may be produced as an odor component due to oxidation of a resin. Examples of the volatile decomposition product that can be adsorbed by the acetic acid-adsorbing material (E) include, but are not necessarily limited to, acetic acid as well as acetaldehyde, formic acid, tert-butyl alcohol, and combinations thereof.

Examples of the acetic acid-adsorbing material (E) include, but are not necessarily limited to, zeolite, silica gel, inorganic layered compounds such as hydrotalcite, and polycarbodiimide. Zeolite is preferable because it can efficiently adsorb the above-mentioned volatile decomposition products and is very versatile. It is preferable that the zeolite is provided with pores having a predetermined size in order to improve the efficiency of adsorption of the volatile decomposition products. The average pore diameter in the zeolite is preferably 0.3 to 1 nm, and more preferably 0.5 to 0.9 nm. If the average pore diameter in the zeolite is out of the range mentioned above, the zeolite does not efficiently adsorb the volatile decomposition products, and thus an unpleasant odor caused by oxygen absorption may be incapable of being appropriately reduced in the obtained resin composition.

An example of zeolite that is useful as the acetic acid-adsorbing material (E) is hydrophobic zeolite with a silica/alumina ratio of 5 or more. For example, such zeolite is commercially available as High Silica Zeolite (HSZ) (registered trademark) from Tosoh Corporation.

The content of the acetic acid-adsorbing material (E) is preferably 0.1 to 20% by mass, more preferably 0.2 to 10% by mass, and even more preferably 0.5 to 8% by mass, with respect to the total amount of the resin composition. In the case where the volatile decomposition products as mentioned above are produced, if the content of the acetic acid-adsorbing material (E) in the resin composition is less than 0.1% by mass, it may be difficult to appropriately adsorb such compounds in the resin composition and prevent an odor component from diffusing to the surrounding environment. If the content of the acetic acid-adsorbing material (E) in the resin composition is more than 20% by mass, the mold processability and handlability of the obtained resin composition may be poor, and when the resin composition is processed into a molded product, mechanical properties such as rigidity and stretchability may be poor. In addition, the hue and transparency of the molded product may deteriorate.

Antioxidant (F)

The resin composition of the present invention may further contain an antioxidant (F) in addition to the ethylene-cyclic olefin copolymer (A) and the transition metal catalyst (B).

The antioxidant (F) is, for example, a compound (e.g., a phenol-based primary antioxidant) that can supplement peroxide radicals produced in the presence of oxygen to prevent a resin from deteriorating due to oxidation.

Examples of the antioxidant (F) include octadecyl 3-(3,5-di-t-butyl-4-hydroxyphenyl)propionate, triethylene glycol-bis[3-(3-t-butyl-5-methyl-4-hydroxyphenyl)propionate], 1,6-hexanediol-bis[3-(3,5-di-t-butyl-4-hydroxyphenyl)propionate], 2,4-bis-(n-octyl)-6-(4-hydroxy-3,5-di-t-butylanilino)-1,3,5-triazine, pentaerythrityl-tetrakis[3-(3,5-di-t-butyl-4-hydroxyphenyl)propionate] (e.g., commercially available under the trade name “IRGANOX 1010” (manufactured by BASF)), 2,2-thio-diethylenebis[3-(3,5-di-t-butyl-4-hydroxyphenylpropionate), octadecyl-3-(3,5-di-t-butyl-4-hydroxyphenyl)propionate (e.g., commercially available under the trade name “IRGANOX 1076” (manufactured by BASF)), N, N′-hexamethylenebis(3,5-di-t-butyl-4-hydroxy-hydrocinnamamide), 3,5-di-t-butyl-4-hydroxybenzylphosphonate-diethyl ester, 1,3,5-trimethyl-2,4,6-tris(3,5-di-t-butyl-4-hydroxybenzyl)benzene, tris-(3,5-di-t-butyl-4-hydroxybenzyl)-isocyanurate, octylated diphenylamine, 2,4-bis[(octylthio)methyl]-o-cresol, isooctyl-3-(3,5-di-t-butyl-4-hydroxyphenyl)propionate, and combinations thereof. Out of these compounds, octadecyl 3-(3,5-di-t-butyl-4-hydroxyphenyl)propionate is preferable because it is favorably dispersed in the ethylene-cyclic olefin copolymer (A).

The content of the antioxidant (F) is preferably 0.001 to 1% by mass, more preferably 0.002 to 0.2% by mass, and even more preferably 0.005 to 0.02% by mass, with respect to the total amount of the resin composition. If the content of the antioxidant (F) in the resin composition is less than 0.001% by mass, an oxidation reaction or cross-linking reaction of the ethylene-cyclic olefin copolymer (A), for example, will progress due to peroxide radicals produced during storage or inside an extruder, which may lead to a poor external appearance after pellet formation or film formation. If the content of the antioxidant (F) is more than 1% by mass, the oxidation of the ethylene-cyclic olefin copolymer (A) will be suppressed, which may lead to the impairment of the oxygen-absorbing properties of the obtained resin composition.

Another Thermoplastic Resin (G) and Additive (H)

The resin composition of the present invention may contain another thermoplastic resin (G) in addition to the ethylene-cyclic olefin copolymer (A) and the EVOH (C) to the extent that the effects of the present invention are not inhibited.

Examples of the thermoplastic resin (G) include polyolefins such as polyethylene, polypropylene, ethylene-propylene copolymers, ethylene copolymers or propylene copolymers (copolymers of ethylene or propylene and at least one of the following monomers: α-olefins such as 1-butene, isobutene, 4-methyl-1-pentene, 1-hexene, and 1-octene; unsaturated carboxylic acid such as itaconic acid, methacrylic acid, acrylic acid, and maleic anhydride, salts thereof, partial or complete esters thereof, nitriles thereof, amides thereof, and anhydrides thereof; vinyl esters of carboxylic acids such as vinyl formate, vinyl acetate, vinyl propionate, vinyl butyrate, vinyl octanoate, vinyl dodecanoate, vinyl stearate, and vinyl arachidonate; vinyl silane compounds such as vinyltrimethoxysilane; unsaturated sulfonic acids and salts thereof; alkyl thiols; vinyl pyrrolidones; and the like), poly(4-methyl-1-pentene), and poly(l-butene); polyesters such as poly(ethylene terephthalate), poly(butylene terephthalate), and poly(ethylene naphthalate); polystyrene; polycarbonates; polyacrylates such as polymethyl methacrylate; polyvinyl alcohols; and combinations thereof. The content of the other thermoplastic resin (G) is preferably 30% by mass or less with respect to the total mass of the resin composition of the present invention.

The resin composition of the present invention may contain another additive (H) to the extent that the functions and effects of the present invention are not inhibited. Examples of the other additive (H) include a viscosity modifier, a plasticizer, a photoinitiator, a deodorant, an ultraviolet absorber, an antistatic agent, a lubricant, a colorant, a drying agent, a filler, a processing aid, a flame retardant, and an antifog agent. There is no particular limitation on the content of the other additive (H), and an appropriate amount can be selected to the extent that the effects of the present invention are not inhibited.

Among the other additives (H), it is preferable to add a thermoplastic resin having a melt flow rate (MFR) higher than that of the ethylene-cyclic olefin copolymer (A) as a viscosity modifier in order to improve the processability of the resin composition of the present invention. Thermoplastic resins whose MFR is, for example, 10 to 1,000 g/10 minutes at 190° C. under a load of 2,160 g are preferable as the viscosity modifier, and specific examples thereof include ethylene-vinyl acetate copolymers, ethylene-methacrylic acid copolymers, ethylene-methyl methacrylate copolymers, and high-density polyethylene. If the MFR is within the range above, the processability can be improved by adding only a small amount of the viscosity modifier. The content thereof is preferably 1% by mass or more and 30% by mass or less with respect to the total mass of the resin composition of the present invention. If the addition amount of the viscosity modifier is less than 1% by mass, it is less effective in improving the processability. If the addition amount of the viscosity modifier is more than 30% by mass, the viscosity will be excessively lowered, and thus the layer may have very uneven thickness when a multilayer structure is manufactured.

Alkaline-Earth Metal Salt (I)

The resin composition of the present invention may further contain an alkaline-earth metal salt (I) in addition to the ethylene-cyclic olefin copolymer (A) and the transition metal catalyst (B).

In the resin composition of the present invention, the alkaline-earth metal salt (I) may be added as a catalyst or cocatalyst as described above during the synthesis of the ethylene-cyclic olefin copolymer (A), and/or may be separately added as another additive.

When added as a catalyst or cocatalyst during the synthesis of the ethylene-cyclic olefin copolymer (A), the alkaline-earth metal salt (I) may be contained, for example, in the state in which it directly binds to the polymer chain of the ethylene-cyclic olefin copolymer (A) through a covalent bond, an ionic bond, a coordination bond, or the like. Examples of the alkaline-earth metal salt (I) include carboxylates. Examples of the carboxylates include magnesium acetate, magnesium formate, magnesium oxalate, magnesium citrate, magnesium malate, magnesium stearate, magnesium tartrate, calcium acetate, calcium formate, calcium oxalate, calcium citrate, calcium malate, calcium stearate, and calcium tartrate. In particular, magnesium acetate, calcium acetate, magnesium stearate, and calcium stearate are preferable.

The content of the alkaline-earth metal salt (I) in terms of the alkaline-earth metal atom is preferably 0.1 to 10,000 ppm, more preferably 1 to 1,000 ppm, and even more preferably 10 to 500 ppm, with respect to the total mass of the resin composition. If the content of the alkaline-earth metal salt (I) satisfies such a range, an increase in torque can be suppressed during melt-kneading and molding processing of a resin composition, and a resin composition exhibiting favorable oxygen-absorbing properties can be obtained. In particular, when the resin composition contains the EVOH (C), it is particularly preferable that the resin composition contains the alkaline-earth metal salt (I) from the viewpoint of improving the oxygen absorbing speed.

The resin composition of the present invention has such oxygen-absorbing properties that oxygen is preferably absorbed in an amount of 0.1 to 300 mL/g, more preferably 0.5 to 200 mL/g, and even more preferably 1.0 to 150 mL/g, for 7 days under the conditions of 60° C. and 10% RH. If the resin composition of the present invention has oxygen-absorbing properties within such a range, the resin composition can maintain high oxygen barrier properties for a long period of time, and a multilayer structure containing the resin composition can maintain high oxygen barrier properties even after retort treatment.

(2) Manufacturing of Resin Composition

The resin composition of the present invention can be manufactured by mixing the above-mentioned components (A) and (B), and, as necessary, one or more of the components (C) to (F). In manufacturing of the resin composition of the present invention, there is no particular limitation on the method for mixing these components, and there is also no particular limitation on the order of components that are to be mixed.

A specific mixing method is preferably the melt-kneading method in view of the process simplicity and the cost. In this case, it is preferable to use an apparatus that has a high kneading ability to allow the components to be finely and uniformly dispersed because this can provide good oxygen-absorbing properties and good transparency and can prevent the generation or introduction of gels or aggregates.

Examples of apparatuses that can provide a high kneading ability include: continuous kneaders such as a continuous intensive mixer, a kneading-type twin-screw extruder (co-rotation or counter-rotation), a mixing roll, and a Ko-kneader; batch kneaders such as a high-speed mixer, a Banbury mixer, an intensive mixer, and a pressure kneader; apparatuses in which a rotary disk with a trituration mechanism having a stone mill-like shape, such as a KCK kneading extruder manufactured by KCK Co., Ltd.; apparatuses with a single-screw extruder provided with a kneading section (such as a Dulmage); and simple kneaders such as a ribbon blender and a Brabender mixer. Among these apparatuses, continuous kneaders are preferable. In the present invention, it is preferable to use an apparatus in which an extruder and a pelletizer are installed in the discharge port of such a continuous kneader to perform kneading, extruding and palletizing simultaneously. Moreover, it is also possible to use twin-screw kneading extruders equipped with a kneading disk or a kneading rotor. A kneader may be used singly, or two or more kneaders may be coupled for use.

It is preferable that the kneading temperature is, for example, in a range of 120° C. to 300° C. In order to prevent oxidation of the ethylene-cyclic olefin copolymer (A) in the resin composition manufacturing steps, it is preferable to perform extrusion at low temperatures with the hopper port sealed with nitrogen. There is no particular limitation on the kneading period, and an appropriate period can be selected by a person skilled in the art depending on the types and amounts of the components (A) to (H) to be used.

(3) Multilayer Structure

The above-mentioned resin composition can be used in an oxygen-absorbing layer of a multilayer structure.

In one embodiment, when a layer made of a resin other than the resin composition of the present invention is defined as an x layer, a layer made of the resin composition of the present invention is defined as a y layer, and an adhesive resin layer is defined as a z layer, examples of the layer configuration of the multilayer structure include, but are not limited to, x/y, x/y/x, x/z/y, x/z/y/z/x, x/y/x/y/x, and x/z/y/z/x/z/y/z/x.

When a plurality of x layers are provided in the multilayer structure, the types of x layers may be the same or different. A layer made of a recycled resin prepared from scraps such as trims produced during molding may be separately provided, or a layer may be made of a blend of the recycled resin and another resin. There is no particular limitation on the thicknesses of the layers of the multilayer structure. However, the ratio of the thickness of the y layer to the total thickness of the layers is preferably 2 to 20% in order to achieve favorable moldability, cost-effectiveness, and the like.

It is preferable to use a thermoplastic resin as the resin for forming the x layer from the viewpoint of processability and the like. Examples of the thermoplastic resin that can be used for the x layer include polyolefins such as polyethylene, polypropylene, ethylene-propylene copolymers, ethylene copolymers or propylene copolymers (copolymers of ethylene or propylene and at least one of the following monomers: α-olefins such as 1-butene, isobutene, 4-methyl-1-pentene, 1-hexene, and 1-octene; ethylene-vinyl acetate copolymers; unsaturated carboxylic acid such as itaconic acid, methacrylic acid, acrylic acid, and maleic anhydride, salts thereof, partial or complete esters thereof, nitriles thereof, amides thereof, and anhydrides thereof; vinyl esters of carboxylic acids such as vinyl formate, vinyl acetate, vinyl propionate, vinyl butyrate, vinyl octanoate, vinyl dodecanoate, vinyl stearate, and vinyl arachidonate; vinyl silane compounds such as vinyltrimethoxysilane; unsaturated sulfonic acids and salts thereof; alkyl thiols; vinyl pyrrolidones; and the like), poly4-methyl-1-pentene, and poly(l-butene); polyesters such as polyethylene terephthalate, polybutylene terephthalate, and polyethylene naphthalate; polyamides such as polyε-caprolactam, poly(hexamethylene adipamide), and poly(m-xylylene adipamide); polyvinylidene chloride, polyvinyl chloride, polystyrene, polyacrylonitrile, polycarbonates and polyacrylates. Such a thermoplastic resin layer may be unstretched, or uniaxially or biaxially stretched, or rolled.

In the above-mentioned thermoplastic resin layer configuration, it is preferable to use a hydrophobic resin having relatively high gas permeability to form an inner layer of the layers other than the oxygen-absorbing layer from the viewpoint of facilitating absorption of oxygen inside the multilayer structure. It is also preferable that such a layer is heat-sealable for some applications of the multilayer structure. Examples of such a resin include polyolefins such as polyethylene and polypropylene, and ethylene-vinyl acetate copolymers. On the other hand, it is preferable to use a resin having excellent moldability and excellent mechanical physical properties to form an outer layer of the multilayer structure. Examples of such a resin include polyolefins such as polyethylene and polypropylene, polyamides, polyesters, polyethers, and polyvinyl chloride.

Furthermore, when the multilayer structure of the present invention is used for a packaging material such as a container, it is preferable that the multilayer structure includes a gas barrier resin layer made of a polyamide, ethylene-vinyl alcohol copolymer, or the like in order to prevent oxygen from entering from the outside of the packaging material. The gas barrier resin layer may also contain the above-mentioned resin composition of the present invention, and it is preferable that the oxygen-absorbing layer containing the resin composition is arranged between the gas barrier resin layer and a content from the viewpoint of efficiently absorbing oxygen present inside the package and remove the oxygen. Furthermore, another layer may be provided between the oxygen-absorbing layer and a layer made of a gas barrier resin.

If the multilayer structure of the present invention is used, for example, for a retort packaging material or a container lid, a polyolefin such as a polyamide, polyester, or polypropylene is used as a thermoplastic resin for forming the outer layer, and polypropylene is particularly preferably used. The inner layer is preferably made of polypropylene. Polyolefins are preferable because of their moisture resistance, mechanical properties, cost, heat-sealing properties and the like. Polyesters are preferable because of their mechanical properties, thermal resistance, and the like.

If the multilayer structure of the present invention is used for, for example, a retort packaging material, it is exposed to high humidity, and therefore, it is preferable to provide a layer having high vapor barrier properties on both sides of the oxygen-absorbing layer or on the side exposed to high humidity when the packaging material is used. With a molded product having such a layer, the retention period of oxygen-absorbing properties is particularly prolonged, and as a result, very high gas barrier properties can be maintained for a longer period of time.

There is no particular limitation on an adherent resin used for the z layer as long as it can bond the layers. Polyurethane- or polyester-based one- or two-component curable adhesives, carboxylic acid-modified polyolefin resins, and the like are favorably used. Examples of the carboxylic acid-modified polyolefin resins include olefin-based polymers or copolymers that contain an unsaturated carboxylic acid or an anhydride thereof (e.g., maleic anhydride) as a copolymerizable component; and graft copolymers obtained by grafting an unsaturated carboxylic acid or an anhydride thereof into olefin-based polymers or copolymers. The carboxylic acid-modified polyolefin resins are particularly preferable. In particular, when the x layer is made of a polyolefin resin, the adhesiveness to the y layer is improved by using a carboxylic acid-modified polyolefin resin for the z layer. Examples of the carboxylic acid-modified polyolefin resin include resins obtained by modifying, with carboxylic acid, polyethylene (e.g., low-density polyethylene (LDPE), linear low-density polyethylene (LLDPE), and very-low-density polyethylene (VLDPE)), polypropylene, copolymerized polypropylene, ethylene-vinyl acetate copolymers, ethylene-(meth)acrylic ester (methyl ester or ethyl ester) copolymers, and the like.

Examples of a method for producing the multilayer structure of the present invention include an extrusion lamination method, a dry lamination method, a coinjection molding method, and a coextrusion molding method. Examples of the coextrusion molding method include a coextrusion lamination method, a coextrusion sheet molding method, a coextrusion inflation molding method, and coextrusion blow molding method. Examples of the multilayer structure obtained through these methods include sheets, films, and parisons.

(4) Applications

A desired molded product can be obtained by reheating a sheet, a film, a parison, or the like of the multilayer structure of the present invention at a temperature below the melting points of the resins contained in the multilayer structure, and uniaxially or biaxially stretching it through thermoforming such as draw forming, rolling, pantographic stretching, inflation stretching, or blow molding.

The obtained molded product can be used as, for example, a packaging material for packaging a predetermined content.

This packaging material has excellent oxygen-absorbing properties, and generation of odor caused by volatile decomposition products produced through oxidation and transfer thereof to a content are suppressed to an extremely low level. Therefore, the packaging material can be favorably used to package contents that tend to deteriorate due to the influence of oxygen. Examples of such contents include foods (e.g., fresh foods, processed foods, chilled foods, frozen foods, freeze-dried foods, prepared meal, and half-cooked foods); beverages (e.g., drinking water, tea beverages, milk beverages, processed milk, soybean milk, coffee, cocoa, soft drinks, soups, and alcoholic beverages (e.g., beer, wine, shochu (Japanese spirits), refined sake, whiskey, and brandy); pet foods (e.g., dog foods and cat foods); feed or forage for livestock, poultry, and farmed fish; oils and fats (e.g., cooking oils and industrial oils); medicines (e.g., medicines available in pharmacies, pharmacist intervention required medicines, nonprescription medicines, and animal medicines), and other drugs. It is particularly preferable to use the multilayer structure of the present invention for a food package for the reason that foods are likely to, for example, deteriorate or rot due to the influence of oxygen, and needs for packaging materials having excellent oxygen-absorbing properties have been growing.

### EXAMPLES

Hereinafter, the present invention will be described in detail by use of examples, but the present invention is not limited to these examples.

### Example I: Preparation of Oxygen-Absorbing Films and Multilayer Structures

(I-a) Evaluation of Oxygen-Absorbing Properties

A 100-mg sample was cut from each of oxygen-absorbing films obtained in Examples I-1 to I-24 and Comparative Examples I-1 to I-5, and was placed in a pressure-resistant glass bottle having a capacity of 35.5 mL under air atmosphere. The bottle was hermetically sealed with an aluminum cap provided with a Naflon rubber packing, and was then stored under the conditions of 40° C. and 22% RH for 14 days. The oxygen concentration in the container after storage was measured using Pack Master (manufactured by Iijima Electronics Corporation).

(I-b) Evaluation of Odor after Oxygen Absorption

Samples that were prepared and stored in the same manner as in (I-a) above were opened, and five professionals evaluated an odor in each container according to the following criteria. The average score of the obtained evaluation results was calculated for each sample. The lower the score was, the smaller the amount of an odor was.

5: Strong choking unpleasant odor.

4: Strong nose-pinching unpleasant odor.

3: Perceptible unpleasant odor.

2: Weak unpleasant odor.

1: Slight unpleasant odor.

0: No unpleasant odor.

(I-c) Analysis of Odor Components after Oxygen Absorption

Each of samples prepared in the same manner as in (I-a) above was placed in a pressure-resistant glass bottle provided with a fluorescence-based oxygen concentration sensor under air atmosphere. The bottle was hermetically sealed with an aluminum cap provided with a Teflon (registered trademark) rubber packing. Until the sample absorbed 2.5 cc of oxygen, which was a portion thereof in the glass container, the sample of Example 1 was stored at 60° C. for 1 day and the sample of Comparative Example I-3 was stored at 60° C. for 3 days. The oxygen concentration in the container was monitored using a portable non-destructive oxygen meter Fibox4 trace (manufactured by PreSens), and the absorption of 2.5 cc of oxygen by the sample was confirmed by a decrease in the oxygen concentration from 20.9 to 14.9%. Next, in a state in which the glass bottle was kept at 60° C., 1.5 cc of gas in the container after storage was collected using a gas-tight syringe that was heated to 60° C., and was then injected into GC-MS (GC System 7890B, detector 5977B MSD, manufactured by Agilent Technologies, column: DB-624 (column length: 60 m, column diameter: 0.25 mm, manufactured by Agilent Technologies), heating conditions: kept at 40° C. for 5 minutes, heated to 150° C. at 5° C./minute, and then heated to 250° C. at 10° C./minute) to analyze produced gas components.

(I-d) Measurement of MFR (Melt Flow Rate)

The MFRs of the ethylene-cyclic olefin copolymer (A), the viscosity modifier, and the resin composition obtained through biaxial kneading were measured at 190° C. under a load of 2,160 g using a melt flow indexer.

### Example I-1: Preparation of Oxygen-Absorbing Film

0.4 parts by mass of manganese stearate serving as the transition metal catalyst (B) was mixed with 100 parts by mass of an EPDM elastomer (“NORDEL IP4770P” manufactured by Dow Chemical Company, Mw=200,000, MFR=0.07 g/10 minutes) constituted by ethylene monomers, propylene monomers, and 5-ethylidene-2-norbornene monomers. The resultant mixture was melt-kneaded using a twin-screw kneading extruder (screw diameter 25 mmφ, L/D=30, manufactured by Toyo Seiki Seisaku-sho, Ltd.) under the conditions of a cylinder temperature of 230° C. and a screw rotation rate of 50 rpm, and was then extruded in a strand shape from the die into a cooling water tank at 5° C. and pelletized into pellets using a strand cutter.

Next, these pellets were charged into a single-layer extruder (screw diameter 20 mmφ, L/D=20, manufactured by Toyo Seiki Seisaku-sho, Ltd.), and were melt-kneaded at a cylinder temperature of 230° C. and a screw rotation rate of 40 rpm. Then, the resulting product was cast from the die to a cooling roll at 20° C., and thus an oxygen-absorbing film having a thickness of 20 μm was obtained.

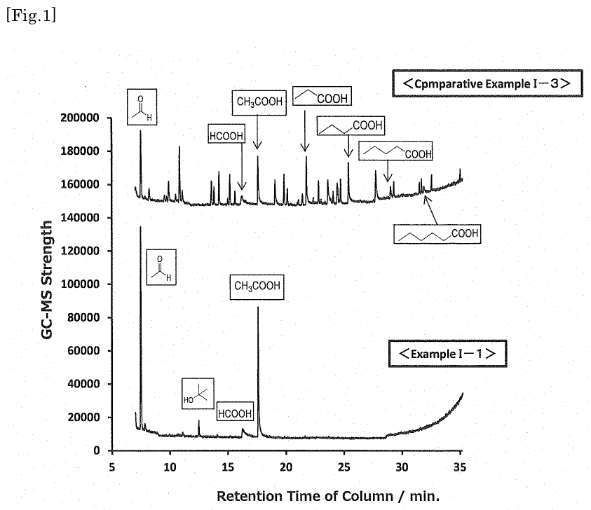

This oxygen-absorbing film was subjected to the above-mentioned evaluation of the oxygen-absorbing properties and the evaluation of an odor after oxygen absorption. Also, odor components were analyzed using GC-MS after the oxygen absorption. The composition of this oxygen-absorbing film is shown in Tables 1 and 2, and the results of Evaluations (I-a) and (I-b) are shown in Table 3. The GC-MS graph indicating the result of Evaluation (I-c) is shown in FIG. 1.

### Examples I-2 to I-6: Preparation of Oxygen-Absorbing Films

Oxygen-absorbing films were prepared and subjected to the above-mentioned evaluations in the same manner as in Example I-1, except that the ethylene-cyclic olefin copolymer (A) was changed to EDPM elastomers constituted by the monomer units shown in Table 1. The compositions of the oxygen-absorbing films are shown in Tables 1 and 2, and the results of Evaluations (I-a) and (I-b) are shown in Table 3.

The EDPM elastomers shown in the column “Type” of Table 1 correspond to the following products.

“NORDEL IP3745P” (manufactured by Dow Chemical Company, Mw=140,000, MFR=0.2 g/10 minutes)

“NORDEL IP4820P” (manufactured by Dow Chemical Company, Mw=75,000, MFR=1 g/10 minutes)

“Mitsui EPT K-9720” (manufactured by Mitsui Chemicals, Inc., Mw=60,000, MFR=2 g/10 minutes)

“Mitsui EPT X-3012P” (manufactured by Mitsui Chemicals, Inc., MFR=5 g/10 minutes)

“RoyalEdge5041” (manufactured by Lion Copolymer Geismar)

### Example I-7: Preparation of Oxygen-Absorbing Film

An oxygen-absorbing film was prepared and subjected to the above-mentioned evaluations in the same manner as in Example I-1, except that the ethylene-cyclic olefin copolymer (A) was changed to “ESPRENE 301A” (EPDM elastomer, Mw=210,000) manufactured by Sumitomo Chemical Co., Ltd., ESPRENE 301A having a bale-like shape was cut into cubes with a side length of 0.5 cm and charged into a twin-screw extruder, and the transition metal catalyst (B) was changed to cobalt stearate. The composition of the oxygen-absorbing film is shown in Tables 1 and 2, and the results of Evaluations (I-a) and (I-b) are shown in Table 3.

### Example I-8: Preparation of Oxygen-Absorbing Film

An oxygen-absorbing film was prepared and subjected to the above-mentioned evaluations in the same manner as in Example I-1, except that the ethylene-cyclic olefin copolymer (A) was changed to an ethylene-norbornene copolymer (“TOPAS E-140” manufactured by Polyplastics Co., Ltd.). The composition of the oxygen-absorbing film is shown in Tables 1 and 2, and the results of Evaluations (I-a) and (I-b) are shown in Table 3.

### Example I-9: Preparation of Oxygen-Absorbing Film

An oxygen-absorbing film was prepared and subjected to the above-mentioned evaluations in the same manner as in Example I-1, except that the transition metal catalyst (B) was changed to cobalt stearate. The composition of the oxygen-absorbing film is shown in Tables 1 and 2, and the results of Evaluations (I-a) and (I-b) are shown in Table 3.

### Example I-10: Preparation of Oxygen-Absorbing Film

An oxygen-absorbing film was prepared and subjected to the above-mentioned evaluations in the same manner as in Example I-9, except that the content of cobalt stearate was changed to 0.021 parts by mass. The composition of the oxygen-absorbing film is shown in Tables and 2, and the results of Evaluations (I-a) and (I-b) are shown in Table 3.

### Example I-11: Preparation of Oxygen-Absorbing Film

An oxygen-absorbing film was prepared and subjected to the above-mentioned evaluations in the same manner as in Example I-9, except that the content of cobalt stearate was changed to 1.073 parts by mass. The composition of the oxygen-absorbing film is shown in Tables and 2, and the results of Evaluations (I-a) and (I-b) are shown in Table 3.

### Example I-12: Preparation of Oxygen-Absorbing Film

An oxygen-absorbing film was produced prepared and subjected to the above-mentioned evaluations in the same manner as in Example I-1, except that the addition amount of manganese stearate was changed to 0.416 parts by mass, 4 parts by mass of zeolite having an average pore diameter of 0.9 nm (“ZEOLUM F-9” manufactured by Tosoh Corporation) serving as the acetic acid adsorbent (C) was further mixed with the EPDM elastomer and manganese stearate, and the mixture was melt-kneaded using a twin-screw extruder. The composition of the oxygen-absorbing film is shown in Tables 1 and 2, and the results of Evaluations (I-a) and (I-b) are shown in Table 3.

### Examples I-13 to I-16: Preparation of Oxygen-Absorbing Films

Oxygen-absorbing films were prepared and subjected to the above-mentioned evaluations in the same manner as in Example I-12, except that the addition amount of manganese stearate and the type and content of the acetic acid adsorbent (C) were changed as shown in Tables and 3. The compositions of the oxygen-absorbing films are shown in Tables 1 and 2, and the results of Evaluations (I-a) and (I-b) are shown in Table 3.

The products shown in the column “Type of acetic acid adsorbent (C)” of Table 2 correspond to the following products.

“HSZ940HOA” (High Silica Zeolite manufactured by Tosoh Corporation) having an average pore diameter of 0.65 nm

“CARBODILITE LA-1” (polycarbodiimide manufactured by Nisshinbo Chemical Inc.)

“Sylysia 310P” (amorphous silica gel manufactured by Fuji Silysia Chemical Ltd.) having an average particle diameter of 2.7 μm and an average pore diameter of 21 nm

### Example I-17: Preparation of Oxygen-Absorbing Film

An oxygen-absorbing film was prepared and subjected to the above-mentioned evaluations in the same manner as in Example I-1, except that the addition amount of the ethylene-cyclic olefin copolymer (A) was changed to 80 parts by mass, 20 parts by mass of a partially hydrogenated styrene-butadiene rubber (“Tuftec P1083” manufactured by Asahi Kasei Chemicals Corporation) serving as the other thermoplastic resin (G) was further mixed with the EPDM elastomer and manganese stearate, and the mixture was melt-kneaded using a twin-screw extruder. The composition of the oxygen-absorbing film is shown in Tables 1 and 2, and the results of Evaluations (I-a) and (I-b) are shown in Table 3.

### Example I-18: Preparation of Oxygen-Absorbing Film

An oxygen-absorbing film was prepared and subjected to the above-mentioned evaluations in the same manner as in Example I-17, except that 8 parts by mass of High Silica Zeolite “HSZ940HOA” serving as the acetic acid adsorbent (C) was further added and the resultant mixture was melt-kneaded using a twin-screw extruder. The composition of the oxygen-absorbing film is shown in Tables 1 and 2, and the results of Evaluations (I-a) and (I-b) are shown in Table 3.

### Example I-19: Preparation of Oxygen-Absorbing Film

An oxygen-absorbing film was prepared and subjected to the above-mentioned evaluations in the same manner as in Example I-17, except that the addition amount of the ethylene-cyclic olefin copolymer (A) was changed to 80 parts by mass, 20 parts by mass of an ethylene-vinyl acetate copolymer (“Evaflex V56113” manufactured by Mitsui Chemicals Inc. (vinyl acetate content=20 wt %, MFR=20 g/10 minutes)) serving as the other thermoplastic resin (G) was further mixed with the EPDM elastomer and manganese stearate, and the resultant mixture was melt-kneaded using a twin-screw extruder. The MFR of the resin composition obtained through biaxial kneading was 0.2 g/10 minutes by adding the ethylene-vinyl acetate copolymer having a high MFR. Therefore, a film could be extruded at a lower torque compared with Example I-1, thus making it possible to more efficiently form the oxygen-absorbing film. The composition of the oxygen-absorbing film is shown in Tables 1 and 2, and the results of Evaluations (I-a) and (I-b) are shown in Table 3.

### Example I-20: Preparation of Oxygen-Absorbing Film

An oxygen-absorbing film was prepared and subjected to the above-mentioned evaluations in the same manner as in Example I-4, except that 0.01 parts by mass of octadecyl 3-(3,5-di-t-butyl-4-hydroxyphenyl)propionate (“Irganox 1076” manufactured by BASF) serving as the antioxidant (F) was further mixed with the EPDM elastomer and manganese stearate, and the resultant mixture was melt-kneaded using a twin-screw extruder. The composition of the oxygen-absorbing film is shown in Tables 1 and 2, and the results of Evaluations (I-a) and (I-b) are shown in Table 3.

### Examples I-21 and I-22: Preparation of Oxygen-Absorbing Films

Oxygen-absorbing films were prepared and subjected to the above-mentioned evaluations in the same manner as in Example I-21, except that the content of the antioxidant (F) was changed as shown in Tables 2 and 3. The compositions of the oxygen-absorbing films are shown in Tables 1 and 2, and the results of Evaluations (I-a) and (I-b) are shown in Table 3.

### Example I-23: Preparation of Oxygen-Absorbing Film

An oxygen-absorbing film was prepared and subjected to the above-mentioned evaluations in the same manner as in Example I-5, except that the addition amount of the EPDM elastomer “Mitsui EPT X-3012P” was changed to 20 parts by mass, 80 parts by mass of a 1-hexene modified L-LDPE (“HARMOREX NF325N” manufactured by Japan Polyethylene Corporation) was further mixed with the EPDM elastomer and manganese stearate, and the resultant mixture was melt-kneaded using a twin-screw extruder. The composition of the oxygen-absorbing film is shown in Tables 1 and 2, and the results of Evaluations (I-a) and (I-b) are shown in Table 3.

### Example I-24: Preparation of Oxygen-Absorbing Film

An oxygen-absorbing film was prepared and subjected to the above-mentioned evaluations in the same manner as in Example I-24, except that the addition amount of the EPDM elastomer “Mitsui EPT X-3012P” was changed to 50 parts by mass, and the addition amount of the 1-hexene modified L-LDPE (“HARMOREX NF325N” manufactured by Japan Polyethylene Corporation) was changed to 50 parts by mass. The composition of the oxygen-absorbing film is shown in Tables 1 and 2, and the results of Evaluations (I-a) and (I-b) are shown in Table 3.

### Comparative Example I-1: Preparation of Oxygen-Absorbing Film

An oxygen-absorbing film was prepared and subjected to the above-mentioned evaluations in the same manner as in Example I-1, except that the ethylene-cyclic olefin copolymer (A) was changed to an ethylene-norbornene copolymer (“TOPAS 6013” manufactured by Polyplastics Co., Ltd.). The composition of the oxygen-absorbing film is shown in Tables 1 and 2, and the results of Evaluations (I-a) and (I-b) are shown in Table 3.

### Comparative Example I-2: Preparation of Oxygen-Absorbing Film

An oxygen-absorbing film was prepared and subjected to the above-mentioned evaluations in the same manner as in Example I-1, except that a 1-hexene modified L-LDPE (“HARMOREX NF325N” manufactured by Japan Polyethylene Corporation) was used instead of the EPDM elastomer. The composition of the oxygen-absorbing film is shown in Tables 1 and 2, and the results of Evaluations (I-a) and (I-b) are shown in Table 3.

### Comparative Example I-3: Preparation of Oxygen-Absorbing Film

An oxygen-absorbing film was prepared and subjected to the above-mentioned evaluations in the same manner as in Example I-1, except that an ethylene-octene copolymer (“ENGAGE 8407” manufactured by Dow Chemical Company) was used instead of the EPDM elastomer. The composition of the oxygen-absorbing film is shown in Tables 1 and 2, and the results of Evaluations (I-a) and (I-b) are shown in Table 3. The GC-MS graph indicating the result of Evaluation (I-c) is shown in FIG. 1.

### Comparative Example I-4: Preparation of Oxygen-Absorbing Film

An oxygen-absorbing film was prepared and subjected to the above-mentioned evaluations in the same manner as in Example I-2, except that manganese stearate was not added. The composition of the oxygen-absorbing film is shown in Tables 1 and 2, and the results of Evaluations (I-a) and (I-b) are shown in Table 3.

### Comparative Example I-5: Preparation of Oxygen-Absorbing Film

An oxygen-absorbing film was prepared and subjected to the above-mentioned evaluations in the same manner as in Example I-1, except that an isoprene rubber (“IR 2200” manufactured by JSR Corporation) was used instead of the EPDM elastomer, and the bale-shaped isoprene rubber IR-2200 was cut into cubes with a side length of 0.5 cm and charged into a twin-screw extruder. The composition of the oxygen-absorbing film is shown in Tables 1 and 2, and the results of Evaluations (I-a) and (I-b) are shown in Table 3.

### Example I-25: Preparation of Multilayer Structure

A metallocene L-LDPE (“UMERIT 3540N” manufactured by Ube-Maruzen Polyethylene) serving as a base resin, a maleic anhydride modified linear low-density polyethylene (“ADMER NF-539” manufactured by Mitsui Chemicals, Inc.) serving as an adherent resin, the resin composition pellets containing the EPDM elastomer “Mitsui EPT K-9720P” that was prepared in Example I-3 and served as an oxygen-absorbing resin, and an ethylene-vinyl alcohol copolymer (“EVAL F101B” manufactured by Kuraray Co., Ltd.) were charged into a first extruder, a second extruder, a third extruder, and a fourth extruder, respectively. Then, a four-type six-layer multilayer film having a layer configuration of L-LDPE (30 μm)/oxygen-absorbing layer (20 μm)/adherent layer (10 μm)/EVOH (20 μm)/adherent layer (10 μm)/L-LDPE (30 μm) was prepared using a four-type six-layer multilayer extruder under the conditions of an extrusion temperature of 180 to 220° C. and a die temperature of 220° C.

Pieces having a size of 22 cm×12 cm were cut from the obtained multilayer film, and 1-cm wide portions at the ends of the four sides thereof were heat-sealed at 150° C. to produce a pouch-like multilayer structure containing air with a capacity of 100 mL and an inner surface area of 200 cm². The multilayer structure was stored at 40° C. for 2 weeks, and then the oxygen concentration in the pouch was measured using Pack Master (manufactured by Iijima Electronics Corporation) to evaluate the oxygen-absorbing properties of the multilayer structure. Pouches that were prepared in the same manner were stored for 2 weeks and were then opened, and five professionals evaluated an odor in each pouch as an odor in the multilayer structure after oxygen absorption according to the following criteria. The average score of the obtained evaluation results was calculated for each sample. The lower the score was, the smaller the amount of odor was.

5: Strong choking unpleasant odor.

4: Strong nose-pinching unpleasant odor.

3: Perceptible unpleasant odor.

2: Weak unpleasant odor.

1: Slight unpleasant odor.

0: No unpleasant odor.

The composition of the multilayer structure constituting this pouch is shown in Tables 1 and 2, and the results of the above-mentioned evaluations are shown in Table 4.

### Comparative Example I-6: Preparation of Multilayer Structure

A four-type six-layer oxygen-absorbing film and a pouch formed using this film were prepared in the same manner as in Example I-25, except that the resin composition pellets containing an ethylene-norbornene copolymer (“TOPAS 6013” manufactured by Polyplastics Co., Ltd.) that was prepared in Comparative Example I-1 and served as an oxygen-absorbing resin were charged into the third extruder in the four-type six-layer multilayer extrusion. Then, the oxygen-absorbing properties of the multilayer structure and an odor in the pouch after oxygen absorption were evaluated. The composition of the multilayer structure constituting this pouch is shown in Tables 1 and 2, and the results of the above-mentioned evaluations are shown in Table 4.

TABLE 1

| | Ethylene-Cyclic | | | | | | | | | |
|---|---|---|---|---|---|---|---|---|---|---|
| | Olefin Copolymer (A) | | | | | | | | | |
| | | Content Ratios of | | | | | | | | Content |
| | | Monomer Units (mol %) | | | | | | | | (Parts |
| | | l | m | m | n | | | | | by |
| | Type | ET | PP | BT | ENB | DCPD | NR | l/n | n/(l + m + n) | Mass) |
| Example I-1 | NORDEL | 79.7 | 19.0 | — | 1.3 | — | — | 61.3 | 0.0132 | 100 |
| | IP4770P | | | | | | | | | |
| Example I-2 | NORDEL | 78.0 | 21.9 | — | 0.1 | — | — | 601 | 0.0013 | 100 |
| | IP3745P | | | | | | | | | |
| Example I-3 | NORDEL | 87.7 | 11.0 | — | 1.3 | — | — | 70.1 | 0.0127 | 100 |
| | IP4820P | | | | | | | | | |
| Example I-4 | Mitsui EPT | 89.8 | — | 7.3 | 2.8 | — | — | 31.8 | 0.0291 | 100 |
| | K-9720 | | | | | | | | | |
| Example I-5 | Mitsui EPT | 80.6 | 18.5 | — | 0.8 | — | — | 96.6 | 0.0084 | 100 |
| | X-3012P | | | | | | | | | |
| Example I-6 | RoyalEdqe5041 | 81.4 | 17.8 | — | — | 0.7 | — | 111.9 | 0.0073 | 100 |
| Example I-7 | ESPRENE | 61.7 | 37.0 | — | — | 1.3 | — | 47.5 | 0.0132 | 100 |
| | 301A | | | | | | | | | |
| Example I-8 | TOPAS | 92.8 | — | — | — | — | 7.2 | 12.9 | 0.0776 | 100 |
| | E-140 | | | | | | | | | |
| Example I-9 | NORDEL | 79.7 | 19.0 | — | 1.3 | — | — | 61.3 | 0.0132 | 100 |
| | IP4770P | | | | | | | | | |
| Example I-10 | NORDEL | 79.7 | 19.0 | — | 1.3 | — | — | 61.3 | 0.0132 | 100 |
| | IP4770P | | | | | | | | | |
| Example I-11 | NORDEL | 79.7 | 19.0 | — | 1.3 | — | — | 61.3 | 0.0132 | 100 |
| | IP4770P | | | | | | | | | |
| Example I-12 | NORDEL | 79.7 | 19.0 | — | 1.3 | — | — | 61.3 | 0.0132 | 100 |
| | IP4770P | | | | | | | | | |
| Example I-13 | NORDEL | 79.7 | 19.0 | — | 1.3 | — | — | 61.3 | 0.0132 | 100 |
| | IP4770P | | | | | | | | | |
| Example I-14 | NORDEL | 79.7 | 19.0 | — | 1.3 | — | — | 61.3 | 0.0132 | 100 |
| | IP4770P | | | | | | | | | |
| Example I-15 | NORDEL | 79.7 | 19.0 | — | 1.3 | — | — | 61.3 | 0.0132 | 100 |
| | IP4770P | | | | | | | | | |
| Example I-16 | NORDEL | 79.7 | 19.0 | — | 1.3 | — | — | 61.3 | 0.0132 | 100 |
| | IP4770P | | | | | | | | | |
| Example I-17 | NORDEL | 79.7 | 19.0 | — | 1.3 | — | — | 61.3 | 0.0132 | 80 |
| | IP4770P | | | | | | | | | |
| Example I-18 | NORDEL | 79.7 | 19.0 | — | 1.3 | — | — | 61.3 | 0.0132 | 80 |
| | IP4770P | | | | | | | | | |
| Example I-19 | NORDEL | 79.7 | 19.0 | — | 1.3 | — | — | 61.3 | 0.0132 | 80 |
| | IP4770P | | | | | | | | | |
| Example I-20 | Mitsui EPT | 89.8 | — | 7.3 | 2.8 | — | — | 31.8 | 0.0291 | 100 |
| | K-9720 | | | | | | | | | |
| Example I-21 | Mitsui EPT | 89.8 | — | 7.3 | 2.8 | — | — | 31.8 | 0.0291 | 100 |
| | K-9720 | | | | | | | | | |
| Example I-22 | Mitsui EPT | 89.8 | — | 7.3 | 2.8 | — | — | 31.8 | 0.0291 | 100 |
| | K-9720 | | | | | | | | | |
| Example I-23 | Mitsui EPT | 80.6 | 18.5 | — | 0.8 | — | — | 96.6 | 0.0084 | 20 |
| | X-3012P | | | | | | | | | |
| Example I-24 | Mitsui EPT | 80.6 | 18.5 | — | 0.8 | — | — | 96.6 | 0.0084 | 50 |
| | X-3012P | | | | | | | | | |
| Comparative | TOPAS | 47.2 | — | — | — | — | 52.8 | 0.89 | 1.1206 | 100 |
| Example I-1 | 6013 | | | | | | | | | |
| Comparative | — | — | — | — | — | — | — | — | — | — |
| Example I-2 | | | | | | | | | | |
| Comparative | — | — | — | — | — | — | — | — | — | — |
| Example I-3 | | | | | | | | | | |
| Comparative | NORDEL | 78.0 | 21.9 | — | 0.1 | — | — | 601.0 | 0.0013 | 100 |
| Example I-4 | IP3745P | | | | | | | | | |
| Comparative | — | — | — | — | — | — | — | — | — | 100 |
| Example I-5 | | | | | | | | | | |
| Example I-25 | Mitsui EPT | 89.8 | — | 7.3 | 2.8 | — | — | 31.8 | 0.0291 | 100 |
| | K-9720 | | | | | | | | | |
| Comparative | TOPAS | 47.2 | — | — | — | — | 52.8 | 0.89 | 1.1206 | 100 |
| Examole I-6 | 6013 | | | | | | | | | |

| | | Transition Metal | | | | |
|---|---|---|---|---|---|---|
| | | Catalyst (B) | | | | |
| | Ethylene-Cyclic | | | Content | | |
| | Olefin Copolymer (A) | | Content | in terms | | |
| | Content | | (Parts | of Metal | | |
| | (% by | | by | Atom | X/Y | X/(Y + Z) |
| | Mass) | Type | Mass) | (ppm) | (ppm/mol %) | (ppm/mol %) |
| Example I-1 | 99.60 | Manganese | 0.4 | 352 | 271 | 17 |
| | | Stearate | | | | |
| Example I-2 | 99.60 | Manganese | 0.4 | 352 | 2713 | 16 |
| | | Stearate | | | | |
| Example I-3 | 99.60 | Manganese | 0.4 | 352 | 281 | 29 |
| | | Stearate | | | | |
| Example I-4 | 99.60 | Manganese | 0.4 | 352 | 125 | 35 |
| | | Stearate | | | | |
| Example I-5 | 99.60 | Manganese | 0.4 | 352 | 422 | 18 |
| | | Stearate | | | | |
| Example I-6 | 99.60 | Manganese | 0.4 | 352 | 484 | 19 |
| | | Stearate | | | | |
| Example I-7 | 99.60 | Cobalt | 0.4 | 352 | 271 | 9 |
| | | Stearate | | | | |
| Example I-8 | 99.60 | Manganese | 0.4 | 352 | 49 | 49 |
| | | Stearate | | | | |
| Example I-9 | 99.60 | Cobalt | 0.4 | 375 | 289 | 18 |
| | | Stearate | | | | |
| Example I-10 | 99.98 | Cobalt | 0.021 | 20 | 15 | 1.0 |
| | | Stearate | | | | |
| Example I-11 | 98.94 | Cobalt | 1.073 | 1000 | 770 | 49 |
| | | Stearate | | | | |
| Example I-12 | 95.77 | Manganese | 0.416 | 352 | 271 | 17 |
| | | Stearate | | | | |
| Example I-13 | 98.62 | Manganese | 0.404 | 352 | 271 | 17 |
| | | Stearate | | | | |
| Example I-14 | 92.22 | Manganese | 0.432 | 352 | 271 | 17 |
| | | Stearate | | | | |
| Example I-15 | 98.62 | Manganese | 0.404 | 352 | 271 | 17 |
| | | Stearate | | | | |
| Example I-16 | 95.77 | Manganese | 0.416 | 352 | 271 | 17 |
| | | Stearate | | | | |
| Example I-17 | 79.68 | Manganese | 0.4 | 352 | 271 | 17 |
| | | Stearate | | | | |
| Example I-18 | 73.78 | Manganese | 0.432 | 352 | 271 | 17 |
| | | Stearate | | | | |
| Example I-19 | 79.68 | Manganese | 0.4 | 352 | 271 | 17 |
| | | Stearate | | | | |
| Example I-20 | 99.59 | Manganese | 0.4 | 352 | 125 | 35 |
| | | Stearate | | | | |
| Example I-21 | 99.55 | Manganese | 0.4 | 352 | 125 | 35 |
| | | Stearate | | | | |
| Example I-22 | 99.11 | Manganese | 0.4 | 350 | 124 | 34 |
| | | Stearate | | | | |
| Example I-23 | 19.92 | Manganese | 0.4 | 352 | 4 | 18 |
| | | Stearate | | | | |
| Example I-24 | 49.80 | Manganese | 0.4 | 352 | 4 | 18 |
| | | Stearate | | | | |
| Comparative | 99.60 | Manganese | 0.4 | 352 | 6.7 | 6.7 |
| Example I-1 | | Stearate | | | | |
| Comparative | — | Manganese | 0.4 | 352 | — | — |
| Example I-2 | | Stearate | | | | |
| Comparative | — | Manganese | 0.4 | 352 | — | — |
| Example I-3 | | Stearate | | | | |
| Comparative | 100.00 | — | — | — | 0 | 0 |
| Example I-4 | | | | | | |
| Comparative | — | Manganese | 0.4 | 352 | — | — |
| Example I-5 | | Stearate | | | | |
| Example I-25 | 99.60 | Manganese | 0.4 | 352 | 125 | 35 |
| | | Stearate | | | | |
| Comparative | 99.60 | Manganese | 0.4 | 352 | 6.7 | 6.7 |
| Examole I-6 | | Stearate | | | | |

ET: Ethylene, PP: Propylene, BT: 1-Butene, ENB: Ethylidene Norbornene, DCPD: Dicyclopentadiene, NR: Norbornene

TABLE 2

| | Acetic Acid | | | | | | |
|---|---|---|---|---|---|---|---|
| | Adsorbent (E) | | | Antioxidant (F) | | | |
| | | Content | | | Content | | |
| | | (Parts | Content | | (Parts | Content | |
| | | by | (% by | | by | (% by | Another Thermoplastic Resin (G) |
| | Type | Mass) | Mass) | Type | Mass) | Mass) | Type |
| Example I-1 | — | — | — | — | — | — | — |
| Example I-2 | — | — | — | — | — | — | — |
| Example I-3 | — | — | — | — | — | — | — |
| Example I-4 | — | — | — | — | — | — | — |
| Example I-5 | — | — | — | — | — | — | — |
| Example I-6 | — | — | — | — | — | — | — |
| Example I-7 | — | — | — | — | — | — | — |
| Example I-8 | — | — | — | — | — | — | — |
| Example I-9 | — | — | — | — | — | — | — |
| Example I-10 | — | — | — | — | — | — | — |
| Example I-11 | — | — | — | — | — | — | — |
| Example I-12 | ZEOLUM | 4 | 3.83 | — | — | — | — |
| | F-9 | | | | | | |
| Example I-13 | HSZ940HOA | 1 | 0.99 | — | — | — | — |
| Example I-14 | HSZ940HOA | 8 | 7.38 | — | — | — | — |
| Example I-15 | CARBODILITE | 1 | 0.99 | — | — | — | — |
| | LA-1 | | | | | | |
| Example I-16 | Sylysia | 4 | 3.83 | — | — | — | — |
| | 310P | | | | | | |
| Example I-17 | — | — | — | — | — | — | Tuftec |
| | | | | | | | P1083 |
| Example I-18 | HSZ940HOA | 8 | 7.38 | — | — | — | Tuftec |
| | | | | | | | P1083 |
| Example I-19 | — | — | — | — | — | — | Evaflex |
| | | | | | | | V56113 |
| Example I-20 | — | — | — | Irganox1076 | 0.01 | 0.01 | — |
| Example I-21 | — | — | — | Irqanox1076 | 0.05 | 0.05 | — |
| Example I-22 | — | — | — | Irganox1076 | 0.5 | 0.50 | — |
| Example I-23 | — | — | — | — | — | — | HARMOREX |
| | | | | | | | NF325N |
| Example I-24 | — | — | — | — | — | — | HARMOREX |
| | | | | | | | NF325N |
| Comparative | — | — | — | — | — | — | — |
| Example I-1 | | | | | | | |
| Comparative | — | — | — | — | — | — | HARMOREX |
| Example I-2 | | | | | | | NF325N |
| Comparative | — | — | — | — | — | — | ENGAGE8407 |
| Example I-3 | | | | | | | |
| Comparative | — | — | — | — | — | — | — |
| Example I-4 | | | | | | | |
| Comparative | — | — | — | — | — | — | IR2200 |
| Example I-5 | | | | | | | |
| Example I-25 | — | — | — | — | — | — | — |
| Comparative | — | — | — | — | — | — | — |
| Example I-6 | | | | | | | |

| | Another Thermoplastic Resin (G) | | | | | | | | |
|---|---|---|---|---|---|---|---|---|---|
| | | | | | | | | Content | |
| | | | | | | | | (Parts | Content |
| | Content Ratios of Monomer Units (mol %) | | | | | | | by | (% by |
| | ET | HX | OT | ST | BD + BT | IP | VA | Mass) | Mass) |
| Example I-1 | — | — | — | — | — | — | — | — | — |
| Example I-2 | — | — | — | — | — | — | — | — | — |
| Example I-3 | — | — | — | — | — | — | — | — | — |
| Example I-4 | — | — | — | — | — | — | — | — | — |
| Example I-5 | — | — | — | — | — | — | — | — | — |
| Example I-6 | — | — | — | — | — | — | — | — | — |
| Example I-7 | — | — | — | — | — | — | — | — | — |
| Example I-8 | — | — | — | — | — | — | — | — | — |
| Example I-9 | — | — | — | — | — | — | — | — | — |
| Example I-10 | — | — | — | — | — | — | — | — | — |
| Example I-11 | — | — | — | — | — | — | — | — | — |
| Example I-12 | — | — | — | — | — | — | — | — | — |
| Example I-13 | — | — | — | — | — | — | — | — | — |
| Example I-14 | — | — | — | — | — | — | — | — | — |
| Example I-15 | — | — | — | — | — | — | — | — | — |
| Example I-16 | — | — | — | — | — | — | — | — | — |
| Example I-17 | — | — | — | 8.4 | 91.6 | — | — | 20 | 19.92 |
| Example I-18 | — | — | — | 8.4 | 91.6 | — | — | 20 | 18.44 |
| Example I-19 | 95.8 | — | — | — | — | — | 4.2 | 20 | 19.92 |
| Example I-20 | — | — | — | — | — | — | — | — | — |
| Example I-21 | — | — | — | — | — | — | — | — | — |
| Example I-22 | — | — | — | — | — | — | — | — | — |
| Example I-23 | 94.1 | 5.9 | — | — | — | — | — | 80 | 79.68 |
| Example I-24 | 94.1 | 5.9 | — | — | — | — | — | 50 | 49.80 |
| Comparative | — | — | — | — | — | — | — | — | — |
| Example I-1 | | | | | | | | | |
| Comparative | 94.1 | 5.9 | — | — | — | — | — | 100 | 99.60 |
| Example I-2 | | | | | | | | | |
| Comparative | 87.5 | — | 12.5 | — | — | — | — | 100 | 99.60 |
| Example I-3 | | | | | | | | | |
| Comparative | — | — | — | — | — | — | — | — | — |
| Example I-4 | | | | | | | | | |
| Comparative | — | — | — | — | — | 100 | — | 100 | 99.60 |
| Example I-5 | | | | | | | | | |
| Example I-25 | — | — | — | — | — | — | — | — | — |
| Comparative | — | — | — | — | — | — | — | — | — |
| Example I-6 | | | | | | | | | |

ET: Ethylene, HX: Hexene, OT: Octene, ST: Styrene, BD + BT: Butadiene, IP: Isoprene, VA: Vinyl Acetate

TABLE 3

| | | Amount of | Evaluation |
|---|---|---|---|
| | Oxygen | Oxygen | of Odor |
| | Concentration | Absorbed | (Average |
| | % | mL/g | Score) |
| Example I-1 | 8.5% | 48 | 3.0 |
| Example I-2 | 12.0% | 36 | 3.2 |
| Example I-3 | 11.2% | 39 | 2.8 |
| Example I-4 | 2.1% | 68 | 3.4 |
| Example I-5 | 10.5% | 41 | 3.0 |
| Example I-6 | 9.3% | 45 | 3.0 |
| Example I-7 | 3.2% | 65 | 3.4 |
| Example I-8 | 13.5% | 30 | 1.8 |
| Example I-9 | 3.3% | 65 | 3.4 |
| Example I-10 | 14.2% | 28 | 1.4 |
| Example I-11 | 0.3% | 73 | 3.6 |
| Example I-12 | 12.0% | 36 | 2.2 |
| Example I-13 | 10.8% | 40 | 2.2 |
| Example I-14 | 16.5% | 19 | 0.4 |
| Example I-15 | 10.5% | 41 | 2.2 |
| Example I-16 | 12.2% | 35 | 2.0 |
| Example I-17 | 3.7% | 63 | 3.0 |
| Example I-18 | 13.0% | 32 | 1.2 |
| Example I-19 | 10.8% | 40 | 2.6 |
| Example I-20 | 2.8% | 66 | 3.2 |
| Example I-21 | 4.0% | 62 | 3.0 |
| Example I-22 | 11.0% | 39 | 2.4 |
| Example I-23 | 11.3% | 38 | 3.4 |
| Example I-24 | 11.6% | 37 | 3.6 |
| Comparative | 20.7% | 0.9 | 0.8 |
| Example I-1 | | | |
| Comparative | 12.3% | 35 | 4.6 |
| Example I-2 | | | |
| Comparative | 15.9% | 21 | 3.8 |
| Example I-3 | | | |
| Comparative | 20.8% | 0.4 | 1.0 |
| Example I-4 | | | |
| Comparative | 5.0% | 59 | 4.8 |
| Example I-5 | | | |

TABLE 4

| | | Amount of | Evaluation |
|---|---|---|---|
| | Oxygen | Oxygen | of Odor |
| | Concentration | Absorbed | (Average |
| | % | mL/g | Score) |
| Example I-25 | 7.3% | 41 | 3.0 |
| Comparative Example I-6 | 20.8% | 0.4 | 0.6 |

As shown in Table 3, in the evaluations of all the oxygen-absorbing films prepared in Examples I-1 to I-24, the oxygen concentration was low and the amount of oxygen absorbed by the film was large compared with, for example, the film of Comparative Example I-1. Such a low oxygen concentration was also observed in Comparative Examples I-2 and I-5, but the evaluation of an odor (sensory evaluation) resulted in a high score in both cases. The evaluations of an odor performed on the oxygen-absorbing films prepared in Examples I-1 to I-25 all resulted in a low score. With all things considered, it can be seen that the oxygen-absorbing films prepared in Examples I-1 to I-24 had excellent oxygen-absorbing properties, and generation of an odor caused by volatile decomposition products after oxygen absorption was suppressed.

Attraction is focused on the types of volatile decomposition product that remained after oxygen absorption. As shown in FIG. 1, when the oxygen-absorbing film prepared in Example I-1 is compared with the film prepared in Comparative Example I-3, it can be seen that a very small number of types of volatile decomposition products remained after oxygen absorption in the former case, and only acetaldehyde, tert-butyl alcohol, and acetic acid were detected through GC-MS. In particular, in Example I-1, fatty acids having 4 or more carbon atoms with a strong odor were not detected at all, whereas they were detected in Comparative Example I-3.

Also, as shown in Table 4, in the evaluations of the multilayer structure prepared in Example I-25, the oxygen concentration was low and the value of the amount of oxygen absorbed in the prepared pouch was large compared with the multilayer structure of Comparative Example I-6. As a result of the evaluation of an odor performed on the multilayer structure prepared in Example I-25, it was found that an unpleasant odor was satisfactorily weak. With all things considered, it can be seen that the multilayer structure prepared in Example I-25 also had excellent oxygen-absorbing properties, and generation of an odor caused by volatile decomposition products after oxygen absorption was also suppressed.

### Example II: Preparation of Pellets, Oxygen-Absorbing Films, and Thermoformed Cups

(II-a) Evaluation of Composition of Ethylene-Cyclic Olefin Copolymer (A)

Each of ethylene-cyclic olefin copolymers (A) synthesized in Examples II-1 to II-16 and Comparative Examples II-1 to II-3 was dissolved in 1,2-dichlorobenzene-d₄ (deuteration solvent) containing chromium (III) acetylacetonate at a concentration of 1.5% by mass, and the copolymerization ratio in the composition thereof was analyzed at 130° C. through ¹H NMR analysis (nuclear magnetic resonance apparatus manufactured by JEOL Ltd., 600 MHz, reference peak: TMS). As the contents of trace branched groups including a butyl group, a pentyl group, and a hexyl group, which were produced during the polymerization, the content ratios thereof in a sample prepared in the same manner were determined through ¹³C NMR analysis. Specifically, the contents of trace branched groups were determined as follows: the contents of a butyl group, a pentyl group, and a hexyl group were respectively determined from the amount of the methylene group next to the butyl terminal carbon (peak at 22.8 ppm), the amount of the methylene group next but one carbon atom to the pentyl terminal carbon (peak at 33.2 ppm), and the amount of the methylene group next but one carbon atom to the hexyl terminal carbon (peak at 32.1 ppm), based on the integral value of signals of all carbon atoms measured other than signals derived from the solvent.

(II-b) Melt Flow Rate (MFR) of Ethylene-Cyclic Olefin Copolymer (A)

The melt flow rate of each of the ethylene-cyclic olefin copolymers (A) synthesized in Examples II-1 to II-16 and Comparative Examples II-1 to II-3 was obtained by measuring the discharge rate (g/10 minutes) of the sample using a melt indexer (“L244” manufactured by Takara Kogyo) under the conditions of a temperature of 190° C. and a load of 2,160 g.

(II-c) Analysis of Amount of Aluminum Metal Contained in Resin Composition or Ethylene-Cyclic Olefin Copolymer (A)

1 mL of concentrated nitric acid (specific gravity: 1.38 g/mL) was added to 0.1 g of the resin composition or ethylene-cyclic olefin copolymer (A) obtained in each of Examples II-1 to II-16, and the resultant mixture was left to stand at ordinary temperature for 60 minutes or longer and was then wet-degraded with microwave. Furthermore, the solution concentration was adjusted through dilution with pure water, and then quantitative analysis was performed using ICP-MS.

(II-d) Evaluation of Oxygen-Absorbing Properties

A 200 mg sample was cut from each of oxygen-absorbing films having a thickness of 20 μm obtained in Examples II-17 to II-32 and Comparative Examples II-4 to II-6, and was placed in a pressure-resistant glass bottle having a capacity of 35.5 mL at 23° C. and a humidity of 65%. The bottle was hermetically sealed with an aluminum cap provided with a Naflon rubber packing, and was then stored at 60° C. for 7 days. The humidity in the container during storage at 60° C. was 10%, which was determined from the water vapor content in air at the time of feeding. The oxygen concentration in the container after storage was measured using Pack Master (manufactured by Iijima Electronics Corporation) at 23° C. and a humidity of 65%.

(II-e) Evaluation of Odor after Oxygen Absorption

Samples that were prepared in the same manner as in (II-d) above and stored under the same conditions for the same period of time were opened at a room temperature of 23° C., and five professionals evaluated an odor in each container according to the following criteria. The average score of the obtained evaluation results was calculated for each sample. The lower the score was, the smaller the amount of odor was.

5: Strong choking unpleasant odor that cannot be continuously smelled for 1 second or longer.

4: Strong nose-pinching unpleasant odor that cannot be continuously smelled for only 1 to 3 seconds.

3: Unpleasant odor that is perceptible but can be continuously smelled for longer than 3 seconds.

2: Weak unpleasant odor.

1: No unpleasant odor at the time of smelling for the first time, but slight unpleasant odor at the time of smelling carefully once again.

0: No unpleasant odor.

(II-0 Analysis of Odor Components (Production Amounts of Butyric Acid and Valeraldehyde) after Oxygen Absorption

Samples prepared in the same manner as in (II-d) above were stored at 60° C. for 7 days. Next, in a state in which the glass bottle was kept at 60° C., 1.5 cc of gas in each container after storage was collected using a gas-tight syringe that was heated to 60° C., and was then injected into GC-MS (GC System 7890B, detector 5977B MSD, manufactured by Agilent Technologies, column: DB-624 (column length: 60 m, column diameter: 0.25 mm, manufactured by Agilent Technologies), heating conditions: kept at 40° C. for 5 minutes, heated to 150° C. at 5° C./minute, and then heated to 250° C. at 10° C./minute) to analyze produced components including butyric acid and valeraldehyde. The detection time of butyric acid was 25 minutes and 30 seconds, and the detection time of valeraldehyde was 20 minutes and 10 seconds. When it could be confirmed from the results of mass spectroscopy performed along with the sample measurement that butyric acid and valeraldehyde were produced, the production amounts (ppm) of butyric acid and valeraldehyde were quantified using calibration curves that were produced in advance. The lower detection limit of each component was ppm, and the peak intensity that was lower than or equal to 5 ppm was defined as being lower than or equal to the lower detection limit. Note that butyric acid and valeraldehyde are compounds that generate a strong odor even in a small amount, and materials from which these compounds are produced in smaller amounts are preferable because the amount of odor generated after oxygen absorption is smaller.

(II-g) Analysis of Dissolved Oxygen Concentration Before and After Retort Treatment

Each of thermoformed cups prepared in Examples II-33 to II-48 and Comparative Examples II-7 to II-9 were fully filled with ion-exchanged water in which the dissolved oxygen concentration was reduced to 1.5 ppm through nitrogen bubbling, and then the ion-exchanged water was sealed by heat-sealing a lid (obtained by dry-laminating a biaxially stretched polypropylene film having a thickness of 50 μm, a biaxially stretched nylon film having a thickness of 50 μm, and an oxygen and water vapor high-barrier film (“KURARISTER C” manufactured by Kuraray Co., Ltd.) having a thickness of 12 μm in the stated order) provided with an oxygen concentration sensor to the cup such that the biaxially stretched polypropylene side was located on the cup side. After the dissolved oxygen concentration was measured at a room temperature of 20° C., a hot-water retort treatment was performed for 30 minutes under the conditions of a temperature of 120° C. and a gage pressure of 0.17 MPa. After the retort treatment, the water was wiped away, the cup was cooled by being left to stand in a room at a room temperature of 20° C. for 4 hours, and then the dissolved oxygen concentration after the retort treatment was measured.

(II-h) Hue of Pellets

The hues (YI value, b value) of pellets obtained in Examples II-1 to II-16 and Comparative Examples II-1 to II-3 were measured using a colorimetric chromometer “ZE-2000” manufactured by Nippon Denshoku Kogyo Co. Ltd. in accordance with ASTM-D2244 (color scale system 2). Also, the hues of the pellets obtained in these examples and comparative examples that had been dried with hot air at 120° C. under air atmosphere for 3 hours were measured in the same manner, and were used as standards for hues after oxidation.

### Example II-1: Preparation of Pellets (EP1)

(1) Polymerization of Copolymer of Ethylene, 1-Butene, and 5-Ethylidene-2-Norbornene

Ethylene (supply speed: 150 L/hour), 1-butene (supply speed: 35 L/hour), and 5-ethylidene-2-norbornene (concentration in the reaction vessel: 5 g/L) were continuously supplied to a continuous polymerization vessel that is provided with a stirring blade and has a capacity of 5 L, and then a copolymerization reaction was caused under the condition of 0.7 MPa while adjusting the temperature of water in a jacket such that the interior temperature was 40° C. A cyclohexane solvent was continuously supplied from the upper portion of the polymerization vessel at a speed of 3 L/hour, while the polymerization solution was continuously extracted from the lower portion of the polymerization vessel such that the volume of the polymerization solution in the polymerization vessel was always 3 L. Note that, as polymerization catalysts, a cyclohexane solution of vanadium (V) trichloride oxide, a cyclohexane solution of diethylaluminum chloride, and a cyclohexane solution of ethylaluminum dichloride were continuously supplied at such a ratio that the metal atom concentrations thereof were 0.5 mmol/L, 1.5 mmol/L, and 1.5 mmol/L, respectively. Furthermore, hydrogen was used as a molecular weight adjuster and was supplied such that the hydrogen concentration in the gas phase in the polymerization vessel was 1 mol %.

Next, the polymerization reaction was stopped by adding a small amount of methanol to the extracted polymerization solution, and the polymer was separated from the solvent through steam stripping and was then washed with water. Then, the polymer was dried at 80° C. under vacuum overnight. In this manner, an ethylene-cyclic olefin copolymer (A) of ethylene, 1-butene, and 5-ethylidene-2-norbornene was obtained at a speed of 90 g/hour.

(II-2) Preparation of Pellets

10 parts by mass of the ethylene-cyclic olefin copolymer (A) obtained as described above, 0.4 parts by mass of cobalt (II) stearate serving as the transition metal catalyst (B), and 90 parts by mass of “EVAL F171” (MFR=1 g/10 minutes at 190° C. under a load of 2,160 g) manufactured by Kuraray Co. Ltd. serving as the ethylene-vinyl alcohol copolymer (C) were mixed. The resultant mixture was melt-kneaded using a twin-screw kneading extruder (screw diameter 25 mmφ, L/D=30, manufactured by Toyo Seiki Seisaku-sho, Ltd.) under the conditions of a cylinder temperature of 230° C. and a screw rotation rate of 100 rpm, and was then extruded in a strand shape from the die into a cooling water tank at 20° C. and pelletized using a strand cutter. Thus, pellets (EP1) of the resin composition were obtained. The hue of the obtained pellets (EP1) was evaluated. The composition of the pellets (EP1) and the result of the hue evaluation are both shown in Table 5.

### Example II-2: Preparation of Pellets (EP2)

A copolymer of ethylene, 1-butene, and 5-ethylidene-2-norbornene was obtained in the same manner as in Example II-1, except that the polymerization temperature was changed from 40° C. to 50° C. Pellets (EP2) were prepared in the same manner as in Example II-1, except that this copolymer of ethylene, 1-butene, and 5-ethylidene-2-norbornene was used. The composition of the obtained pellets (EP2) and the result of the hue evaluation are both shown in Table 5.

### Example II-3: Preparation of Pellets (EP3)

A copolymer of ethylene, propylene, and 5-ethylidene-2-norbornene was obtained in the same manner as in Example II-1, except that, in the polymerization process, propylene was used instead of 1-butene, the supply speed of propylene was set to 50 L/hour, and the concentration of 5-ethylidene-2-norbornene in the reaction vessel was changed to 2 g/L. Pellets (EP3) were prepared in the same manner as in Example II-1, except that this copolymer of ethylene, propylene, and 5-ethylidene-2-norbornene was used. The composition of the obtained pellets (EP3) and the result of the hue evaluation are both shown in Table 5.

### Example II-4: Preparation of Pellets (EP4)

A copolymer of ethylene, propylene, and 5-ethylidene-2-norbornene was obtained in the same manner as in Example II-1, except that, in the polymerization process, propylene was used instead of 1-butene, the supply speed of propylene was set to 50 L/hour, the concentration of 5-ethylidene-2-norbornene in the reaction vessel was changed to 2 g/L, the types of catalysts were changed to a cyclohexane solution of a metallocene catalyst dichloro[rac-ethylenebis(4,5,6,7-tetrahydro-1-indenyl)]zirconium (IV) (manufactured by Aldrich) and a cyclohexane solution of methyl aluminoxane prepared using the method described in a non-patent document (J. Polym. Sci., Part A 1988, 26, 3089.), and the concentrations of these catalysts in the reaction vessel were 0.1 mmol/L and 3 mmol/L, respectively. Pellets (EP4) were prepared in the same manner as in Example II-1, except that this copolymer of ethylene, propylene, and 5-ethylidene-2-norbornene was used. The composition of the obtained pellets (EP4) and the result of the hue evaluation are both shown in Table 5.

### Example II-5: Preparation of Pellets (EP5)

A copolymer of ethylene, propylene, and 5-ethylidene-2-norbornene was obtained in the same manner as in Example II-1, except that, in the polymerization process, propylene was used instead of 1-butene, the supply speed of propylene was set to 50 L/hour, the concentration of 5-ethylidene-2-norbornene in the reaction vessel was changed to 2 g/L, the types of catalysts were changed to a cyclohexane solution of a metallocene catalyst dichloro[rac-ethylenebis(4,5,6,7-tetrahydro-1-indenyl)]zirconium (IV) (manufactured by Aldrich) and a cyclohexane solution of triphenylmethylium tetrakis(pentafluorophenylborate) (manufactured by Tokyo Chemical Industry Co., Ltd.), and the concentrations of these catalysts in the reaction vessel were 0.1 mmol/L and 0.1 mmol/L, respectively. Pellets (EP5) were prepared in the same manner as in Example II-1, except that this copolymer of ethylene, propylene, and 5-ethylidene-2-norbornene was used. The composition of the obtained pellets (EP5) and the result of the hue evaluation are both shown in Table 5.

### Example II-6: Preparation of Pellets (EP6)

A copolymer of ethylene, propylene, and 5-ethylidene-2-norbornene was obtained in the same manner as in Example II-1, except that, in the polymerization process, propylene was used instead of 1-butene, the supply speed of propylene was set to 80 L/hour, the concentration of 5-ethylidene-2-norbornene in the reaction vessel was changed to 2 g/L, the types of catalysts were changed to a cyclohexane solution of a metallocene catalyst dichloro[rac-ethylenebis(4,5,6,7-tetrahydro-1-indenyl)]zirconium (IV) (manufactured by Aldrich) and a cyclohexane solution of methyl aluminoxane prepared using the method described in a non-patent document (J. Polym. Sci., Part A 1988, 26, 3089.), and the concentrations of these catalysts in the reaction vessel were 0.1 mmol/L and 3 mmol/L, respectively. Pellets (EP6) were prepared in the same manner as in Example II-1, except that this copolymer of ethylene, propylene, and 5-ethylidene-2-norbornene was used. The composition of the obtained pellets (EP6) and the result of the hue evaluation are both shown in Table 5.

### Example II-7: Preparation of Pellets (EP7)

30 parts by mass of pellets of a copolymer of ethylene, propylene, and 5-ethylidene-2-norbornene (NORDEL IP4820P manufactured by Dow Chemical Company) and 70 parts by mass of acetone were placed in a 5 L separable flask provided with a stirring blade, and were refluxed under nitrogen atmosphere overnight while heated in an oil bath at 60° C. Thus, acetone-soluble components contained in the copolymer of ethylene, propylene, and 5-ethylidene-2-norbornene were eluted. The pellets were filtered out and washed with a large amount of acetone, and were then dried at 60° C. under vacuum to remove acetone contained in the pellets. Pellets (EP7) were prepared in the same manner as in Example II-1, except that such pellets of the copolymer of ethylene, propylene, and 5-ethylidene-2-norbornene were used. The composition of the obtained pellets (EP7) is shown in Table 5.

### Example II-8: Preparation of Pellets (EP8)

30 parts by mass of pellets of a copolymer of ethylene, propylene, and 5-ethylidene-2-norbornene (NORDEL IP4770P manufactured by Dow Chemical Company) and 70 parts by mass of acetone were placed in a 5 L separable flask provided with a stirring blade, and were refluxed under nitrogen atmosphere overnight while heated in an oil bath at 60° C. Thus, acetone-soluble components contained in the copolymer of ethylene, propylene, and 5-ethylidene-2-norbornene were eluted. The pellets were filtered out and washed with a large amount of acetone, and were then dried at 60° C. under vacuum to remove acetone contained in the pellets. Pellets (EP8) were prepared in the same manner as in Example II-1, except that such pellets of the copolymer of ethylene, propylene, and 5-ethylidene-2-norbornene were used. The composition of the obtained pellets (EP8) is shown in Table 5.

It was confirmed that a large amount of die buildup was produced in the die when the resin composition was biaxially kneaded to produce the pellets (EP8).

### Example II-9: Preparation of Pellets (EP9)

A bale of a copolymer of ethylene, propylene, and dicyclopentadiene (ESPRENE 301A manufactured by Sumitomo Chemical Co., Ltd.) was cut into cubes with a side length of 3 cm, and 5 parts by mass of this copolymer was dissolved in 100 parts by mass of cyclohexane at 80° C. The obtained solution was cooled to room temperature and was then subjected to reprecipitation with a large amount of acetone while stirred at a high speed. A precipitated solid was dried under vacuum at 80° C. The obtained solid was cut into cubes with a side length of 5 mm. Pellets (EP9) were prepared in the same manner as in Example II-1, except that the cut solids were used. The composition of the obtained pellets (EP9) is shown in Table 5.

It was confirmed that a large amount of die buildup was produced in the die when the resin composition was biaxially kneaded to produce the pellets (EP9).

### Example II-10: Preparation of Pellets (EP10)

30 parts by mass of pellets of a copolymer of ethylene and 2-norbornene (TOPAS E-140 manufactured by Polyplastics Co., Ltd.) and 70 parts by mass of acetone were placed in a 5 L separable flask provided with a stirring blade, and were refluxed under nitrogen atmosphere overnight while heated in an oil bath at 60° C. Thus, acetone-soluble components contained in the copolymer of ethylene and 2-norbornene were eluted. The pellets were filtered out and washed with a large amount of acetone, and were then dried at 60° C. under vacuum to remove acetone contained in the pellets. Pellets (EP10) were prepared in the same manner as in Example II-1, except that such pellets of the copolymer of ethylene and 2-norbornene were used. The composition of the obtained pellets (EP10) is shown in Table 5.

### Example II-11: Preparation of Pellets (EP11)

30 parts by mass of pellets of a copolymer of ethylene, 1-butene, and 5-ethylidene-2-norbornene (Mitsui EPT K-9720 manufactured by Mitsui Chemicals, Inc.) and 70 parts by mass of acetone were placed in a 5 L separable flask provided with a stirring blade, and were refluxed under nitrogen atmosphere overnight while heated in an oil bath at 60° C. Thus, acetone-soluble components contained in the copolymer of ethylene and 2-norbornene were eluted. The pellets were filtered out and washed with a large amount of acetone, and were then dried at 60° C. under vacuum to remove acetone contained in the pellets. Pellets (EP11) were prepared in the same manner as in Example II-1, except that such pellets of the copolymer of ethylene, 1-butene, and 5-ethylidene-2-norbornene were used. The composition of the obtained pellets (EP11) is shown in Table 5.

### Example II-12: Preparation of Pellets (EP12)

Pellets (EP12) were prepared in the same manner as in Example II-1, except that 0.4 parts by mass of manganese (II) stearate was used instead of cobalt (II) stearate. The composition of the obtained pellets (EP12) and the result of the hue evaluation are both shown in Table 5.

### Example II-13: Preparation of Pellets (EP13)

Pellets (EP13) were prepared in the same manner as in Example II-1, except that, in the preparation of pellets, 0.01 parts by mass of an antioxidant (Irganox 1076 manufactured by BASF Japan) was further added to the twin-screw kneading extruder, and the content of the ethylene-vinyl alcohol copolymer (C) was changed to 89.99 parts by mass. The composition of the obtained pellets (EP13) and the result of the hue evaluation are both shown in Table 5.

### Example II-14: Preparation of Pellets (EP14)

30 parts by mass of pellets of a copolymer of ethylene, 1-butene, and 5-ethylidene-2-norbornene (Mitsui EPT K-9720 manufactured by Mitsui Chemicals, Inc.) and 70 parts by mass of acetone were placed in a 5 L separable flask provided with a stirring blade, and were refluxed under nitrogen atmosphere overnight while heated in an oil bath at 60° C. Thus, acetone-soluble components contained in the copolymer of ethylene and 2-norbornene were eluted. The pellets were filtered out and washed with a large amount of acetone, and were then dried at 60° C. under vacuum to remove acetone contained in the pellets. Pellets (EP14) were prepared in the same manner as in Example II-1, except that such pellets of the copolymer of ethylene, 1-butene, and 5-ethylidene-2-norbornene were used, 2 parts by mass of a plasticizer (HI-WAX 800P manufactured by Mitsui Chemicals, Inc.; low-molecular-weight HDPE, molecular weight: 8,000, density: 0.970 kg/cm³) was further added to the twin-screw kneading extruder, and the content of the pellets of ethylene, 1-butene, and 5-ethylidene-2-norbornene from which additives had been removed using acetone was changed to 8 parts by mass. The composition of the obtained pellets (EP14) is shown in Table 5.

### Example II-15: Preparation of Pellets (EP15)

30 parts by mass of pellets of a copolymer of ethylene, 1-butene, and 5-ethylidene-2-norbornene (Mitsui EPT K-9720 manufactured by Mitsui Chemicals, Inc.) and 70 parts by mass of acetone were placed in a 5 L separable flask provided with a stirring blade, and were refluxed under nitrogen atmosphere overnight while heated in an oil bath at 60° C. Thus, acetone-soluble components contained in the copolymer of ethylene and 2-norbornene were eluted. The pellets were filtered out and washed with a large amount of acetone, and were then dried at 60° C. under vacuum to remove acetone contained in the pellets. Pellets (EP15) were prepared in the same manner as in Example II-1, except that such pellets of the copolymer of ethylene, 1-butene, and 5-ethylidene-2-norbornene were used, 4 parts by mass of a plasticizer (HI-WAX 800P manufactured by Mitsui Chemicals, Inc.; low-molecular-weight HDPE, molecular weight: 8,000, density: 0.970 kg/cm³) was further added to the twin-screw kneading extruder, the content of the pellets of ethylene, 1-butene, and 5-ethylidene-2-norbornene from which additives had been removed using acetone was changed to 16 parts by mass, and the content of the ethylene-vinyl alcohol copolymer (C) was changed to 80 parts by mass. The composition of the obtained pellets (EP15) is shown in Table 5.

### Example II-16: Preparation of Pellets (EP16)

30 parts by mass of pellets of a copolymer of ethylene, propylene, and 5-ethylidene-2-norbornene (NORDEL IP4770P manufactured by Dow Chemical Company) and 70 parts by mass of acetone were placed in a 5 L separable flask provided with a stirring blade, and were refluxed under nitrogen atmosphere overnight while heated in an oil bath at 60° C. Thus, acetone-soluble components contained in the copolymer of ethylene, propylene, and 5-ethylidene-2-norbornene were eluted. The pellets were filtered out and washed with a large amount of acetone, and were then dried at 60° C. under vacuum to remove acetone contained in the pellets. Pellets (EP16) were prepared in the same manner as in Example II-1, except that such pellets of the copolymer of ethylene, propylene, and 5-ethylidene-2-norbornene were used, 3 parts by mass of an ethylene-methyl methacrylate copolymer (ACRYFT WK-402 manufactured by Sumitomo Chemical Co., Ltd.; methyl methacrylate content: 25 wt %, MFR=20 g/10 minutes) was further added to the twin-screw kneading extruder, and the content of the pellets of ethylene, propylene, and 5-ethylidene-2-norbornene was changed to 7 parts by mass. The composition of the obtained pellets (EP16) is shown in Table 5.

### Example II-17: Preparation of Pellets (EP17)

30 parts by mass of pellets of a copolymer of ethylene, propylene, and 5-ethylidene-2-norbornene (NORDEL IP4770P manufactured by Dow Chemical Company) and 70 parts by mass of acetone were placed in a 5 L separable flask provided with a stirring blade, and were refluxed under nitrogen atmosphere overnight while heated in an oil bath at 60° C. Thus, acetone-soluble components contained in the copolymer of ethylene, propylene, and 5-ethylidene-2-norbornene were eluted. The pellets were filtered out and washed with a large amount of acetone, and were then dried at 60° C. under vacuum to remove acetone contained in the pellets. Pellets (EP17) were prepared in the same manner as in Example II-1, except that such pellets of the copolymer of ethylene, propylene, and 5-ethylidene-2-norbornene were used, 3 parts by mass of an ethylene-methacrylic acid copolymer (NUCREL N1035 manufactured by Dow-Mitsui Polychemicals Co., Ltd.; methacrylic acid content: 10 wt %, MFR=35 g/10 minutes) was further added to the twin-screw kneading extruder, and the content of the pellets of ethylene, propylene, and 5-ethylidene-2-norbornene was changed to 7 parts by mass. The composition of the obtained pellets (EP17) is shown in Table 5.

### Example II-18: Preparation of Pellets (EP18)

30 parts by mass of pellets of a copolymer of ethylene, propylene, and 5-ethylidene-2-norbornene (NORDEL IP4770P manufactured by Dow Chemical Company) and 70 parts by mass of acetone were placed in a 5 L separable flask provided with a stirring blade, and were refluxed under nitrogen atmosphere overnight while heated in an oil bath at 60° C. Thus, acetone-soluble components contained in the copolymer of ethylene, propylene, and 5-ethylidene-2-norbornene were eluted. The pellets were filtered out and washed with a large amount of acetone, and were then dried at 60° C. under vacuum to remove acetone contained in the pellets. Pellets (EP18) were prepared in the same manner as in Example II-1, except that such pellets of the copolymer of ethylene, propylene, and 5-ethylidene-2-norbornene were used, 0.45 parts by mass of calcium (II) stearate was added to the twin-screw kneading extruder as an alkaline-earth metal salt, 3 parts by mass of an ethylene-methacrylic acid copolymer (NUCREL N1035 manufactured by Dow-Mitsui Polychemicals Co., Ltd.; methacrylic acid content: 10 wt %, MFR=35 g/10 minutes) was added thereto, and the content of the pellets of ethylene, propylene, and 5-ethylidene-2-norbornene was changed to 7 parts by mass. The composition of the obtained pellets (EP18) is shown in Table 5.

It was confirmed that production of die buildup in the die, which was confirmed in Example 8 (Preparation of Pellets (EP8)) was significantly reduced when the resin composition was biaxially kneaded to produce the pellets (EP16, 17, 18) above.

### Comparative Example II-1: Preparation of Pellets (CP1)

Pellets (CP1) were prepared in the same manner as in Example II-1, except that 10 parts by mass of polyoctenylene (ring-opening metathesis polymer of cyclooctene) (Veatenamer 8020 manufactured by Evonik Industries AG) was used instead of the copolymer of ethylene, 1-butene, and 5-ethylidene-2-norbornene, and the content of cobalt (II) stearate was changed to 0.2 parts by mass. The composition of the obtained pellets (CP1) and the result of the hue evaluation are both shown in Table 5.

### Comparative Example II-2: Preparation of Pellets (CP2)

Pellets (CP2) were prepared in the same manner as in Example II-1, except that the copolymer of ethylene, 1-butene, and 5-ethylidene-2-norbornene was not contained, and the content of the ethylene-vinyl alcohol copolymer (C) was changed to 100 parts by mass. The composition of the obtained pellets (CP2) is shown in Table 5.

### Comparative Example II-3: Preparation of Pellets (CP3)

Pellets (CP3) were prepared in the same manner as in Example II-1, except that 10 parts by mass of 1-hexene modified L-LDPE (HARMOREX NF325N manufactured by Japan Polyethylene Corporation) was used instead of the copolymer of ethylene, 1-butene, and 5-ethylidene-2-norbornene. The composition of the obtained pellets (CP3) is shown in Table 5.

TABLE 5

| | | Ethylene-Cyclic Olefin Copolymer (A) | | | | | | | | | |
|---|---|---|---|---|---|---|---|---|---|---|---|
| | | | | | | | | | | Total Amount of | |
| | | | | | | | | | | Branching of | |
| | | | | | | | | | | Butyl Group, | |
| | | | | | | | | | | Pentyl Group | |
| | | | | | | | | | Content | and Hexyl Group | |
| | | Content Ratios of | | | | | | MFR | (Parts | (Number of | Aluminum |
| | Pellet | Monomer Units (mol %) | | | | | | g/10 | by | Branches/1000 | Content of |
| | Name | ET | PP | BT | ENB | DCPO | MR | min. | Mass) | Carbon Atoms) | (A)(ppm) |
| Example II-1 | EP1 | 91.8 | — | 5.4 | 2.8 | — | — | 2 | 10 | 2.5 | 100 |
| Example II-2 | EP2 | 91.8 | — | 5.4 | 2.8 | — | — | 2 | 10 | 8.4 | 100 |
| Example II-3 | EP3 | 88.7 | 10.0 | — | 1.3 | — | — | 1 | 10 | 2.2 | 100 |
| Example II-4 | EP4 | 88.7 | 10.0 | — | 1.3 | — | — | 1 | 10 | 0.4 | 100 |
| Example II-5 | EP5 | 88.7 | 10.0 | — | 1.3 | — | — | 1 | 10 | 0.6 | 0 |
| Example II-6 | EP6 | 78.7 | 20.0 | — | 1.3 | — | — | 0.8 | 10 | 0.3 | 100 |
| Example II-7 | EP7 | 87.7 | 11.0 | — | 1.3 | — | — | — | 10 | 0.2 | 4 |
| Example II-8 | EP8 | 79.7 | 19.0 | — | 1.3 | — | — | 0.07 | 10 | 0.3 | 10 |
| Example II-9 | EP9 | 62.7 | 37.0 | — | — | 1.3 | — | 0.05 | 10 | 1.5 | 10 |
| Example II-10 | EP10 | 92.8 | — | — | — | — | 7.2 | 3 | 10 | 0.7 | 0.3 |
| Example II-11 | EP11 | 80.8 | — | 7.3 | 2.8 | — | — | 2 | 10 | 1.8 | 97 |
| Example II-12 | EP12 | 91.8 | — | 5.4 | 2.8 | — | — | 2 | 10 | 2.5 | 100 |
| Example II-13 | EP13 | 68.7 | 10.0 | — | 1.3 | — | — | 1 | 10 | 0.4 | 10 |
| Example II-14 | EP14 | 69.8 | — | 7.3 | 2.8 | — | — | 2 | 8 | 1.8 | 97 |
| Example II-15 | EP15 | 69.6 | — | 7.3 | 2.0 | — | — | 2 | 16 | 1.8 | 97 |
| Example II-16 | EP16 | 79.7 | 19.0 | — | 1.3 | — | — | 0.07 | 7 | 0.3 | 7 |
| Example II-17 | EP17 | 79.7 | 19.0 | — | 1.3 | — | — | 0.07 | 7 | 0.3 | 7 |
| Example II-13 | EP18 | 78.7 | 19.0 | — | 1.3 | — | — | 0.07 | 7 | 0.3 | 7 |
| Comparative | CP1 | — | — | — | — | — | — | — | — | — | — |
| Example II-1 | | | | | | | | | | | |
| Comparative | CP2 | — | — | — | — | — | — | — | — | — | — |
| Example II-2 | | | | | | | | | | | |
| Comparative | CP3 | — | — | — | — | — | — | — | — | — | — |
| Example II-3 | | | | | | | | | | | |

| | Transition Metal | | | Alkaline Earth | | | | | |
|---|---|---|---|---|---|---|---|---|---|
| | Catalyst (B) | | | Metal Salt (I) | | | Ethylene-Vinyl Alcohol | | |
| | | | Content | | | Content | Copolymer (C) | | |
| | | Content | in terms | | Content | in terms | | | Content |
| | | (Parts | of Metal | | (Parts | of Metal | | Ethylene | (Parts |
| | | by | Atom | | by | Atom | | Content | by |
| | Type | Mass) | (ppm) | Type | Moss) | (ppm) | Type | (mol %) | Mass) |
| Example II-1 | Cobalt | 0.4 | 352 | — | — | — | EVAL | 32 | 90 |
| | Stearate | | | | | | F171 | | |
| Example II-2 | Cobalt | 0.4 | 352 | — | — | — | EVAL | 32 | 90 |
| | Stearate | | | | | | F171 | | |
| Example II-3 | Cobalt | 0.4 | 352 | — | — | — | EVAL | 32 | 90 |
| | Stearate | | | | | | F171 | | |
| Example II-4 | Cobalt | 0.4 | 352 | — | — | — | EVAL | 32 | 90 |
| | Steerate | | | | | | F171 | | |
| Example II-5 | Cobalt | 0.4 | 352 | — | — | — | EVAL | 32 | 50 |
| | Stearate | | | | | | F171 | | |
| Example II-6 | Cobalt | 0.4 | 352 | — | — | — | EVAL | 32 | 90 |
| | Stearate | | | | | | F171 | | |
| Example II-7 | Cobalt | 0.4 | 352 | — | — | — | EVAL | 32 | 90 |
| | Stearate | | | | | | F171 | | |
| Example II-8 | Cobalt | 0.4 | 352 | — | — | — | EVAL | 32 | 90 |
| | Stearate | | | | | | F171 | | |
| Example II-9 | Cobalt | 0.4 | 352 | — | — | — | EVAL | 32 | 90 |
| | Stearate | | | | | | F171 | | |
| Example II-10 | Cobalt | 0.4 | 352 | — | — | — | EVAL | 32 | 90 |
| | Stearate | | | | | | F171 | | |
| Example II-11 | Cobalt | 0.4 | 352 | — | — | — | EVAL | 32 | 90 |
| | Stearate | | | | | | F171 | | |
| Example II-12 | Manganese | 0.4 | 352 | — | — | — | EVAL | 32 | 90 |
| | Stearate | | | | | | F171 | | |
| Example II-13 | Cobalt | 0.4 | 352 | — | — | — | EVAL | 32 | 89.99 |
| | Stearate | | | | | | F171 | | |
| Example II-14 | Cobalt | 0.4 | 352 | — | — | — | EVAL | 32 | 90 |
| | Stearate | | | | | | F171 | | |
| Example II-15 | Cobalt | 0.4 | 352 | — | — | — | EVAL | 32 | 80 |
| | Stearate | | | | | | F171 | | |
| Example II-16 | Cobalt | 0.4 | 352 | — | — | — | EVAL | 32 | 90 |
| | Stearate | | | | | | F171 | | |
| Example II-17 | Cobalt | 0.4 | 352 | — | — | — | EVAL | 32 | 90 |
| | Stearate | | | | | | F171 | | |
| Example II-13 | Cobalt | 0.4 | 350 | Calcium | 0.45 | 2.95 | EVAL | 32 | 90 |
| | Stearate | | | Stearate | | | F171 | | |
| Comparative | Cobalt | 0.2 | 176 | — | — | — | EVAL | 32 | 90 |
| Example II-1 | Stearate | | | | | | F171 | | |
| Comparative | Cobalt | 0.4 | 352 | — | — | — | EVAL | 32 | 90 |
| Example II-2 | Stearate | | | | | | F171 | | |
| Comparative | Cobalt | 0.4 | 352 | — | — | — | EVAL | 32 | 100 |
| Example II-3 | Stearate | | | | | | F171 | | |

| | Another | | Antioxidant | | | | |
|---|---|---|---|---|---|---|---|
| | Additive (H) | | (F) | | | | |
| | | Content | Content | Hue of Pellets | | | |
| | | (Parts | (Parts | YI | | b Value | |
| | | by | by | Before | After | Before | After |
| | Type | Mass) | Mass) | Oxidation | Oxidation | Oxidation | Oxidation |
| Example II-1 | — | — | — | 9.3 | 17.7 | −0.5 | 2.9 |
| Example II-2 | — | — | — | 10.5 | 18.8 | −3.2 | 3.1 |
| Example II-3 | — | — | — | 8.1 | 13.4 | −1.6 | 1.1 |
| Example II-4 | — | — | — | 5.5 | 12.1 | −1.8 | 0.5 |
| Example II-5 | — | — | — | 5.1 | 11.2 | −1.8 | 0.3 |
| Example II-6 | — | — | — | 7.5 | 15.1 | −1.1 | 2.5 |
| Example II-7 | — | — | — | — | — | — | — |
| Example II-8 | — | — | — | — | — | — | — |
| Example II-9 | — | — | — | — | — | — | — |
| Example II-10 | — | — | — | — | — | — | — |
| Example II-11 | — | — | — | — | — | — | — |
| Example II-12 | — | — | — | 15 | 30 | 2 | 9.5 |
| Example II-13 | — | — | 0.01 | 5.5 | 11.1 | −1.6 | 0.7 |
| Example II-14 | HI-WAX 800P | 2 | — | — | — | — | — |
| Example II-15 | HI-WAX 800P | 4 | — | — | — | — | — |
| Example II-16 | ACRYFT | 3 | — | — | — | — | — |
| | WK-402 | | | | | | |
| Example II-17 | NUCREL | 3 | — | — | — | — | — |
| Example II-13 | N1035 | 3 | — | — | — | — | — |
| Comparative | Vestenamer | 10 | — | 25.4 | 38.8 | 7.5 | 11.7 |
| Example II-1 | 8020 | | | | | | |
| Comparative | — | — | — | — | — | — | — |
| Example II-2 | | | | | | | |
| Comparative | HARMOREX | 10 | — | — | — | — | — |
| Example II-3 | NF225N | | | | | | |

ET: Ethylene, PP: Propylene, BT: 1-Butene, ENB: 5-Etylidene-2-Norbornen, DCPD: Dicyclopentadiene, NR: 2-Norbomen

### Example II-19: Preparation of Oxygen-Absorbing Film (EF1)

The pellets (EP1) obtained in Example II-1 were charged into a single-layer extruder (screw diameter 20 mmφ, L/D=20, manufactured by Toyo Seiki Seisaku-sho, Ltd.), and were melt-kneaded at a cylinder temperature of 220° C. and a screw rotation rate of 100 rpm. Then, the resulting product was cast from the die to a cooling roll at 80° C., and thus an oxygen-absorbing film (EF1) having a thickness of 20 μm was obtained. This oxygen-absorbing film (EF1) was subjected to the above-mentioned oxygen absorption test, the evaluation of an odor after oxygen absorption, and the evaluation of decomposition products. The results are shown in Table 6.

### Examples II-20 to II-36: Preparation of Oxygen-Absorbing Films (EF2) to (EF18)

Oxygen-absorbing films (EF2) to (EF18) were obtained in the same manner as in Example II-19, except that the pellets (EP2) to (EP18) prepared in Examples II-2 to II-18 were used instead of the pellets (EP1) prepared in Example II-1. These oxygen-absorbing films (EF2) to (EP18) were subjected to the above-mentioned oxygen absorption test, the evaluation of odor after oxygen absorption, and the evaluation of decomposition products. The results are shown in Table 6.

Note that many fish eyes were observed in the oxygen-absorbing films (EF8) and (EF9) obtained in Examples II-26 and II-27. On the other hand, it was confirmed that the number of fish eyes was significantly reduced in the oxygen-absorbing films (EF16 to EF18) obtained in Examples II-32 to II-34 compared with, for example, the oxygen-absorbing film (EF8).

### Comparative Examples II-4 to II-6: Preparation of Oxygen-Absorbing Films (CF1) to (CF3)

Oxygen-absorbing films (CF1) to (CF3) were formed in the same manner as in Example II-17, except that the pellets (CP1) to (CP3) prepared in Comparative Examples II-1 to II-3 were used instead of the pellets (EP1) prepared in Example II-1. These oxygen-absorbing films (CF1) to (CF3) were subjected to the above-mentioned oxygen absorption test, the evaluation of odor after oxygen absorption, and the evaluation of decomposition products. The results are shown in Table 6.

TABLE 6

| | | | | | | | | | | | Evaluation of | Evaluation of |
|---|---|---|---|---|---|---|---|---|---|---|---|---|
| | | | Oxygen | | | | | | | | Decomposition | Decomposition |
| | | | Absorption Test | | Evaluation of Odor | | | | | | Products | Products |
| | | | | Amount of | | | | | | Evaluation | Production | Production |
| | | | Oxygen | Oxygen | | | | | | of Odor | Amounts of | Amounts of |
| | Film | Name of | Concentration | Absorbed | Score by Each Panelist | | | | | (Average | Butyric Acid | Valeraldehyde |
| | Name | Pellet Used | (%) | (mL/g) | A | B | C | D | E | Score) | (ppm) | (ppm) |
| Example II-19 | EF1 | EP1 | 13.2 | 16 | 2 | 2 | 2 | 2 | 2 | 2.0 | <5 | <5 |
| Example II-20 | EF2 | EP2 | 12.7 | 17 | 3 | 4 | 4 | 3 | 3 | 3.4 | 10 | <5 |
| Example II-21 | EF3 | EP3 | 15.0 | 12 | 2 | 1 | 2 | 1 | 2 | 1.6 | <5 | <5 |
| Example II-22 | EF4 | EP4 | 15.5 | 12 | 1 | 1 | 2 | 1 | 2 | 1.4 | <5 | <5 |
| Example II-23 | EF5 | EP5 | 16.0 | 12 | 1 | 1 | 2 | 1 | 1 | 1.2 | <5 | <5 |
| Example II-24 | EF6 | EP6 | 13.8 | 14 | 2 | 2 | 1 | 2 | 2 | 1.8 | <6 | <5 |
| Example II-25 | EF7 | EP7 | 15.0 | 14 | 2 | 1 | 2 | 1 | 2 | 1.6 | <5 | <5 |
| Example II-26 | EF8 | EP8 | 14.2 | 15 | 2 | 1 | 2 | 2 | 2 | 1.8 | <5 | <5 |
| Example II-27 | EF9 | EP9 | 13.9 | 15 | 3 | 2 | 3 | 3 | 2 | 2.6 | <5 | <5 |
| Example II-28 | EF10 | EP10 | 15.0 | 12 | 1 | 2 | 1 | 0 | 1 | 1.0 | <5 | <5 |
| Example II-29 | EF11 | EP11 | 13.2 | 15 | 2 | 2 | 2 | 2 | 2 | 2.0 | <5 | <5 |
| Example II-30 | EF12 | EP12 | 15.2 | 12 | 2 | 1 | 2 | 1 | 2 | 1.6 | <5 | <5 |
| Example II-31 | EF13 | EP13 | 16.2 | 10 | 1 | 1 | 1 | 2 | 1 | 1.2 | <5 | <5 |
| Example II-32 | EF14 | EP14 | 13.7 | 15 | 2 | 3 | 2 | 2 | 3 | 2.4 | <5 | <5 |
| Example II-33 | EF15 | EP15 | 5.0 | 30 | 3 | 3 | 4 | 3 | 3 | 3.2 | <5 | <5 |
| Example II-34 | EF16 | EP16 | 16.0 | 10 | 1 | 2 | 2 | 2 | 1 | 1.6 | 10 | <5 |
| Example II-35 | EF17 | EP17 | 15.2 | 12 | 2 | 2 | 2 | 2 | 1 | 1.8 | <5 | <5 |
| Example II-36 | EF18 | EP18 | 14.2 | 15 | 2 | 3 | 3 | 2 | 2 | 2.4 | <5 | <5 |
| Comparative | CF1 | CP1 | 1.2 | 35 | 5 | 4 | 4 | 5 | 4 | 4.4 | <5 | 230 |
| Example II-4 | | | | | | | | | | | | |
| Comparative | CF2 | CP2 | 20.5 | 1 | 1 | 2 | 1 | 1 | 2 | 1.4 | <5 | <5 |
| Example II-5 | | | | | | | | | | | | |
| Comparative | CF3 | CP3 | 17.2 | 8 | 4 | 3 | 4 | 4 | 4 | 3.8 | 120 | 10 |
| Example II-6 | | | | | | | | | | | | |

As shown in Table 6, the oxygen-absorbing films (EF1) to (EF18) prepared in Examples II-19 to II-36 absorbed a larger amount of oxygen compared with the films (CF2) and (CF3) obtained in Comparative Examples II-5 and II-6 that contained no ethylene-cyclic olefin copolymer (A). Note that the film (CF3) of Comparative Example II-4 absorbed a large amount of oxygen, but the average score thereof for the odor evaluation was significantly high compared with the evaluations of the oxygen-absorbing films (EF1) to (EF18) prepared in Examples II-19 to II-36. Furthermore, it can be seen that valeraldehyde was detected in Comparative Examples II-4 and II-6, whereas it was observed that substantially no valeraldehyde was generated from the oxygen-absorbing films (EF1) to (EF18) prepared in Examples II-19 to II-36.

### Example II-37: Preparation of Thermoformed Cup (EC1)

Polypropylene (NOVATEC EA7AD manufactured by Japan Polypropylene Corporation) serving as a base resin, a maleic anhydride modified polypropylene (ADMER QF-500 manufactured by Mitsui Chemicals, Inc.) serving as an adherent resin, and the pellets (EP1) obtained in Example 1 serving as an oxygen-absorbing resin were charged into a first extruder, a second extruder, and a third extruder, respectively. Then, a three-type five-layer multilayer sheet having a layer configuration of polypropylene (320 μm)/adherent layer (45 μm)/oxygen-absorbing resin layer (80 μm)/adherent layer (40 μm)/polypropylene (320 μm) was prepared using a three-type five-layer multilayer extruder under the conditions of an extrusion temperature of to 230° C. and a die temperature of 230° C.

A thermoformed cup (EC1) was prepared by molding this multilayer sheet using a vacuum/pressure forming machine (manufactured by Asano Lab.) at a draw ratio of 0.5 under the conditions of a sheet surface temperature of 190° C. and a pressure of 0.3 MPa. This thermoformed cup (EC1) was subjected to the above-mentioned evaluation of oxygen barrier properties during retort treatment. The results are shown in Table 7.

### Examples II-38 to II-54: Preparation of Thermoformed Cups (EC2) to (EC18)

Thermoformed cups (EC2) to (EC18) were prepared in the same manner as in Example II-37, except that the pellets (EP2) to (EP18) prepared in Examples II-2 to II-18 were used instead of the pellets (EP1) prepared in Example II-1. These thermoformed cups (EC2) to (EC18) were subjected to the above-mentioned evaluation of oxygen barrier properties during retort treatment. The results are shown in Table 7.

### Comparative Examples II-7 to II-9: Preparation of Thermoformed Cups (CC1) to (CC3)

Thermoformed cups (CC1) to (CC3) were prepared in the same manner as in Example II-33, except that the pellets (CP1) to (CP3) prepared in Comparative Examples II-1 to II-3 were used instead of the pellets (EP1) prepared in Example II-1. These thermoformed cups (CC1) to (CC3) were evaluated for oxygen barrier properties during the above-mentioned retort treatment. The results are shown in Table 7.

TABLE 7

| | | | Oxygen Barrier Properties | |
|---|---|---|---|---|
| | | | during Retort Treatment | |
| | | | Dissolved | Dissolved Oxygen |
| | | | Oxygen | Concentration after |
| | | | Concentration | Retort Treatment |
| | | Name of | before Retort | (ppm) |
| | Cup | Pellet | Treatment | Condition: 120° |
| | Name | Used | (ppm) | C. × 30 min. |
| Example II-37 | EC1 | EP1 | 1.5 | 3.1 |
| Example II-38 | EC2 | EP2 | 1.5 | 3.0 |
| Example II-39 | EC3 | EP3 | 1.5 | 3.5 |
| Example II-40 | EC4 | EP4 | 1.5 | 3.5 |
| Example II-41 | EC5 | EP5 | 1.5 | 3.8 |
| Example II-42 | EC6 | EP6 | 1.5 | 3.3 |
| Example II-43 | EC7 | EP7 | 1.5 | 3.6 |
| Example II-44 | EC8 | EP8 | 1.5 | 3.5 |
| Example II-45 | EC9 | EP9 | 1.5 | 3.0 |
| Example II-46 | EC10 | EP10 | 1.5 | 3.7 |
| Example II-47 | EC11 | EP11 | 1.5 | 3.1 |
| Example II-48 | EC12 | EP12 | 1.5 | 3.1 |
| Example II-49 | EC13 | EP13 | 1.5 | 4.0 |
| Example II-50 | EC14 | EP14 | 1.5 | 2.1 |
| Example II-51 | EC15 | EP15 | 1.5 | 1.7 |
| Example II-52 | EC16 | EP16 | 1.5 | 3.9 |
| Example II-53 | EC17 | EP17 | 1.5 | 3.7 |
| Example II-54 | EC18 | EP18 | 1.5 | 2.8 |
| Comparative | CC1 | CP1 | 1.5 | 1.5 |
| Example II-7 | | | | |
| Comparative | CC2 | CP2 | 1.5 | 5.5 |
| Example II-8 | | | | |
| Comparative | CC3 | CP3 | 1.5 | 4.9 |
| Example II-9 | | | | |

It can be seen that the thermoformed cups (EC1) to (EC18) prepared in Examples II-37 to II-54 exhibited excellent oxygen barrier properties during retort treatment because, as shown in Table 7, they could suppress the dissolved oxygen concentration after the retort treatment to a lower level compared with the thermoformed cups (CC2) and (CC3) of Comparative Examples II-8 and II-9 formed using the pellets (CP2) and (CP3) that contained no ethylene-cyclic olefin copolymer (A).

### INDUSTRIAL APPLICABILITY

The resin composition of the present invention is useful for packaging various products in the fields of, for example, foods and beverages, pet foods, fat and oil industry, medicines, and the like.

1. A resin composition comprising:
an ethylene-cyclic olefin copolymer (A) that includes repeating units including ethylene units and norbornene units having a substituent R¹ and is represented by Formula (I): 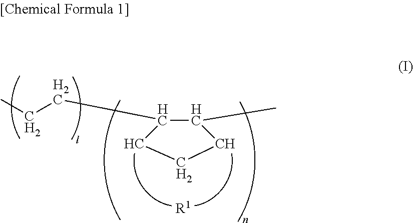
where R¹ represents an ethylene group or an ethylene group that is subjected to substitution with an aliphatic hydrocarbon group having 1 to 3 carbon atoms, l and n represent the content ratios of the ethylene units and the norbornene units having a substituent R¹, respectively, and the ratio of l to n (l/n) is 4 or more and 2,000 or less; and
a transition metal catalyst (B).

2. The resin composition according to claim 1, wherein the ethylene-cyclic olefin copolymer (A) includes repeating units including ethylene units, ethylene units having a substituent R², and norbornene units having a substituent R¹ and is represented by Formula (II): 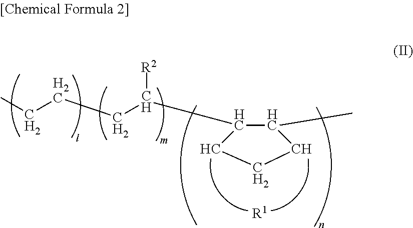
where R¹ represents an ethylene group or an ethylene group that is subjected to substitution with an aliphatic hydrocarbon group having 1 to 3 carbon atoms, R² represents an aliphatic hydrocarbon group having 1 to 8 carbon atoms, l, m, and n represent the content ratios of the ethylene units, the ethylene units having a substituent R², and the norbornene units having a substituent R¹, respectively, and
l, m, and n satisfy a relationship represented by Expression (III):
0.0005≤n/(l+m+n)≤0.2 (III).

3. The resin composition according to claim 2, wherein R² in Formula (II) is at least one group selected from the group consisting of linear, branched, or cyclic alkyl groups having 1 to 8 carbon atoms; linear, branched, or cyclic alkenyl groups having 2 to 8 carbon atoms; and linear, branched, or cyclic alkynyl groups having 2 to 8 carbon atoms.

4. The resin composition according to claim 1, wherein R¹ in Formula (I) or (II) is an ethylene group that is subjected to substitution with at least one aliphatic hydrocarbon group selected from the group consisting of linear, branched, or cyclic alkyl groups having 1 to 3 carbon atoms; linear, branched, or cyclic alkenyl groups having 2 to 3 carbon atoms; alkynyl groups having 2 to 3 carbon atoms; and linear or branched alkylidene groups having 2 to 3 carbon atoms.

5. The resin composition according to claim 1, wherein R¹ in Formula (I) or (II) is an ethylidene ethylene group.

6. The resin composition according to claim 1, wherein a main chain of the ethylene-cyclic olefin copolymer (A) includes only single bonds.

7. The resin composition according to claim 1,
wherein the ethylene-cyclic olefin copolymer (A) is a copolymer that has a branched chain constituted by at least one alkyl group selected from the group consisting of an n-butyl group, an n-pentyl group, and an n-hexyl group, and
in the ethylene-cyclic olefin copolymer (A), the total number of alkyl groups constituting the branched chain per 1,000 carbon atoms determined using ¹³C NMR is 0.001 to 50.

8. The resin composition according to claim 1, which has such oxygen-absorbing properties that oxygen is absorbed in an amount of 0.1 to 300 mL/g for 7 days under the conditions of 60° C. and 10% RH.

9. (canceled)

10. The resin composition according to claim 1, wherein a content X (ppm) of the transition metal catalyst (B) in terms of a metal atom and a content ratio Y (mol %) of the norbornene units having a substituent R¹ to all monomer units included in the ethylene-cyclic olefin copolymer (A) satisfy Expression (IV):
11≤X/Y≤10,000 (IV).

11. The resin composition according to claim 2, wherein a content X (ppm) of the transition metal catalyst (B) in terms of a metal atom, a content ratio Y (mol %) of the norbornene units having a substituent R¹ to all monomer units included in the ethylene-cyclic olefin copolymer (A), and a content ratio Z (mol %) of the ethylene units having a substituent R² to all monomer units included in the ethylene-cyclic olefin copolymer (A) satisfy Expression (V):
0.1≤X/(Y+Z)≤150 (V).

12. The resin composition according to claim 1, wherein the content of the ethylene-cyclic olefin copolymer (A) is 25.0 to 99.9% by mass with respect to the total amount of the resin composition.

13. The resin composition according to claim 1, further comprising an ethylene-vinyl alcohol copolymer (C).

14. The resin composition according to claim 13, wherein the content of the ethylene-cyclic olefin copolymer (A) is 0.5 to 50% by mass with respect to the total amount of the resin composition.

15. The resin composition according to claim 13, wherein the content of the ethylene-vinyl alcohol copolymer (C) is 50 to 99.5% by mass with respect to the total amount of the resin composition.

16. The resin composition according to claim 13, further comprising an alkaline-earth metal salt, wherein the content of the alkaline-earth metal salt in terms of a metallic element is 1 to 1,000 ppm.

17. The resin composition according to claim 1, further comprising an aluminum compound (D), wherein the aluminum compound is contained in an amount of 0.1 to 10,000 ppm in terms of an aluminum metal atom.

18. The resin composition according to claim 1, further comprising an acetic acid-adsorbing material (E).

19. The resin composition according to claim 18, wherein the acetic acid-adsorbing material (E) contains zeolite, and the content of the zeolite is 0.1 to 20% by mass with respect to the total amount of the resin composition.

20. (canceled)

21. The resin composition according to claim 1, further comprising an antioxidant (F), wherein the content of the antioxidant is 0.001 to 1% by mass with respect to the total amount of the resin composition.

22. The resin composition according to claim 1,
wherein the ethylene-cyclic olefin copolymer (A) has an MFR of 2 g/10 minutes or less at 190° C. under a load of 2,160 g,
a viscosity modifier having an MFR of 10 g/10 minutes or more at 190° C. under a load of 2,160 g is further contained, and
the content of the viscosity modifier is 1 to 30% by mass with respect to the total amount of the resin composition.

23. A multilayer structure comprising at least one oxygen-absorbing layer containing the resin composition according to claim 1.

24. The multilayer structure according to claim 23, comprising at least one gas barrier resin layer.

25. A packaging material made of the multilayer structure according to claim 24.

26. A packaged product comprising:
a content; and
the packaging material according to claim 25 for enclosing the content,
wherein the oxygen-absorbing layer in the packaging material is arranged between the gas barrier resin layer in the packaging material and the content.

27. The packaged product according to claim 26, wherein the content is food.
